(19) United States
(12) Patent Application Publication
(10) Pub. No.: US 2025/0052855 A1
(43) Pub. Date: Feb. 13, 2025

(54) GROUPING SPACE VEHICLE BASED POSITIONING REFERENCE SIGNALS AND MEASUREMENTS

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/721,182

(22) PCT Filed: Jan. 13, 2023
(86) PCT No.: PCT/US2023/010824

§ 371 Date: Jun. 17, 2024

(30) Foreign Application Priority Data
Feb. 17, 2022 (GR) 20220100144

(51) Int. Cl. G01S 5/10; G01S 5/00; H04L 5/00

(52) U.S. Cl. CPC G01S 5/10; G01S 5/0009; H04L 5/0048

(57) ABSTRACT

Support for user equipment (UE) positioning with a non-terrestrial network (NTN) considers the significantly different propagation delays of positioning signals transmitted by SVs (SVs) in different orbits and elevation angles. The UE may be configured with a discontinuous measurement gap set for each positioning occasion, including separate measurement gaps for positioning signals transmitted by different SVs. Prioritization based on expected reference signal time differences (RSTD) may be used so that positioning signals received by the UE at nearly the same time are measured with higher priority. A burst configuration based on orbital position of SVs may be used so that positioning signals from different SVs will arrive at the UE within a maximum time window. The UE may provide a capability message indicating a maximum search window and uncertainty supported for NTNs, which may be used to configure the positioning signals to be measured by the UE.

### CROSS-REFERENCE TO RELATED APPLICATION

This application claims the benefit of Greece Patent Application Serial No. 20220100144, entitled “SYSTEMS AND METHODS FOR GROUPING SPACE VEHICLE BASED POSITIONING REFERENCE SIGNALS AND MEASUREMENTS” and filed on Feb. 17, 2022, which is expressly incorporated by reference herein in its entirety.

### BACKGROUND

### Field of the Disclosure

Various aspects described herein generally relate to wireless communication systems, and more particularly, to accessing a wireless network using communication space vehicles.

### Description of Related Technology

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Standardization is ongoing to combine satellite-based communication systems with terrestrial wireless communications systems, such as 5G New Radio (NR) networks. In such a system, a user equipment (UE) would access a satellite or other similar platform, also referred to as a space vehicle (SV), instead of a base station, which would connect to an earth station, also referred to as a ground station or non-terrestrial (NTN) gateway, which in turn would connect to a 5G network (e.g., directly or via a base station). A 5G network could treat the satellite system as another type of Radio Access Technology (RAT) distinct from, but also similar to, terrestrial 5G NR.

Since SVs typically differ from terrestrial base stations in terms of the size of their coverage areas, movement of coverage areas, longer propagation delays and different carrier frequencies, a 5G satellite RAT may need different implementation and support than a 5G terrestrial RAT for providing common services to end users. It may then be preferable to both optimize, and to minimize the impact for, such different implementation and support.

### SUMMARY

Support for user equipment (UE) positioning with a non-terrestrial network considers the significantly different propagation delays of positioning signals transmitted by space vehicles (SVs) in different Earth orbits and elevation angles. The UE may be configured with a discontinuous measurement gap set for each positioning occasion that includes separate measurement gaps used for receiving positioning signals transmitted by different SVs. Prioritization based on expected reference signal time differences (RSTD) may be used by the UE so that positioning signals that are received by the UE at nearly the same time are measured with higher priority. A burst configuration of positioning signals from different SVs based on orbital position of the SVs may be used so that the positioning signals from SVs will arrive at the UE within a maximum time window. The UE may provide a capability message indicating a maximum search window and uncertainty that the UE supports for non-terrestrial networks, which may be used to configure the positioning signals to be measured by the UE.

In one implementation, a method performed by a user equipment (UE) for supporting positioning of the UE in a non-terrestrial network, the method includes receiving configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SVs comprises a plurality of separate measurement gaps; receiving the DL PRS from the plurality of SVs using the discontinuous measurement gap set; performing positioning measurements using the DL PRS from the plurality of SVs; and transmitting location information based on the positioning measurements to a location server.

In one implementation, a user equipment (UE) configured for supporting positioning of the UE in a non-terrestrial network, includes at least one wireless transceiver configured to wirelessly communicate with entities in the non-terrestrial network; at least one memory; and at least one processor coupled to the at least one wireless transceiver and the at least one memory and configured to: receive, via the at least one wireless transceiver, configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SVs comprises a plurality of separate measurement gaps; receive, via the at least one wireless transceiver, the DL PRS from the plurality of SVs using the discontinuous measurement gap set; perform positioning measurements using the DL PRS from the plurality of SVs; and transmit, via the at least one wireless transceiver, location information based on the positioning measurements to a location server.

In one implementation, a user equipment (UE) configured for supporting positioning of the UE in a non-terrestrial network, includes means for receiving configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SVs comprises a plurality of separate measurement gaps; means for receiving the DL PRS from the plurality of SVs using the discontinuous measurement gap set; means for performing positioning measurements using the DL PRS from the plurality of SVs; and means for transmitting location information based on the positioning measurements to a location server.

In one implementation, a non-transitory computer-readable storage medium including program code stored thereon, the program code is operable to configure at least one processor in a user equipment (UE) configured for supporting positioning of the UE in a non-terrestrial network, the program code comprising instructions to: receive configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SVs comprises a plurality of separate measurement gaps; receive the DL PRS from the plurality of SVs using the discontinuous measurement gap set; perform positioning measurements using the DL PRS from the plurality of SVs; and transmit location information based on the positioning measurements to a location server.

In one implementation, a method performed by a network entity for supporting positioning of a user equipment (UE) in a non-terrestrial network, the method includes receiving a request for measurement gaps for positioning measurements in the non-terrestrial network; and providing to the UE configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SVs comprises a plurality of separate measurement gaps for each positioning occasion.

In one implementation, a network entity configured for supporting positioning of a user equipment (UE) in a non-terrestrial network, includes an external interface configured to wirelessly communicate with entities in the non-terrestrial network; at least one memory; and at least one processor coupled to the external interface and the at least one memory and configured to: receive, via the external interface, a request for measurement gaps for positioning measurements in the non-terrestrial network; and provide, via the external interface, to the UE configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SVs comprises a plurality of separate measurement gaps for each positioning occasion.

In one implementation, a network entity configured for supporting positioning of a user equipment (UE) in a non-terrestrial network, includes means for receiving a request for measurement gaps for positioning measurements in the non-terrestrial network; and means for providing to the UE configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SVs comprises a plurality of separate measurement gaps for each positioning occasion.

In one implementation, a non-transitory computer-readable storage medium including program code stored thereon, the program code is operable to configure at least one processor in a network entity for supporting positioning of a user equipment (UE) in a non-terrestrial network, the program code comprising instructions to: receive a request for measurement gaps for positioning measurements in the non-terrestrial network; and provide to the UE configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SVs comprises a plurality of separate measurement gaps for each positioning occasion.

In one implementation, a method performed by a user equipment (UE) for supporting positioning of the UE in a non-terrestrial network, the method includes receiving positioning assistance data for downlink (DL) positioning resources from a plurality of space vehicles (SVs) in the non-terrestrial network, wherein the positioning assistance data comprises at least one of expected reference signal time differences (RSTD) for the DL positioning resources from the plurality of SVs and an elevation angle of each of the plurality of SVs; determining prioritization of the DL positioning resources from the plurality of SVs based on the at least one of the expected RSTD for the DL positioning resources from the plurality of SVs and at least one of the elevation angle of each of the plurality of SVs and an Earth orbit of each of the plurality of SVs, or a combination thereof; and measuring the DL positioning resources using the prioritization for the DL positioning resources.

In one implementation, a user equipment (UE) configured for supporting positioning of the UE in a non-terrestrial network, includes at least one wireless transceiver configured to wirelessly communicate with entities in the non-terrestrial network; at least one memory; and at least one processor coupled to the at least one wireless transceiver and the at least one memory and configured to: receive, via the at least one wireless transceiver, positioning assistance data for downlink (DL) positioning resources from a plurality of space vehicles (SVs) in the non-terrestrial network, wherein the positioning assistance data comprises at least one of expected reference signal time differences (RSTD) for the DL positioning resources from the plurality of SVs and an elevation angle of each of the plurality of SVs; determine prioritization of the DL positioning resources from the plurality of SVs based on the at least one of the expected RSTD for the DL positioning resources from the plurality of SVs and at least one of the elevation angle of each of the plurality of SVs and an Earth orbit of each of the plurality of SVs, or a combination thereof; and measure the DL positioning resources using the prioritization for the DL positioning resources.

In one implementation, a user equipment (UE) configured for supporting positioning of the UE in a non-terrestrial network, includes means for receiving positioning assistance data for downlink (DL) positioning resources from a plurality of space vehicles (SVs) in the non-terrestrial network, wherein the positioning assistance data comprises at least one of expected reference signal time differences (RSTD) for the DL positioning resources from the plurality of SVs and an elevation angle of each of the plurality of SVs; means for determining prioritization of the DL positioning resources from the plurality of SVs based on the at least one of the expected RSTD for the DL positioning resources from the plurality of SVs and at least one of the elevation angle of each of the plurality of SVs and an Earth orbit of each of the plurality of SVs, or a combination thereof; and means for measuring the DL positioning resources using the prioritization for the DL positioning resources.

In one implementation, a non-transitory computer-readable storage medium including program code stored thereon, the program code is operable to configure at least one processor in a user equipment (UE) for supporting positioning of the UE in a non-terrestrial network, the program code comprising instructions to: receive positioning assistance data for downlink (DL) positioning resources from a plurality of space vehicles (SVs) in the non-terrestrial network, wherein the positioning assistance data comprises at least one of expected reference signal time differences (RSTD) for the DL positioning resources from the plurality of SVs and an elevation angle of each of the plurality of SVs; determine prioritization of the DL positioning resources from the plurality of SVs based on the at least one of the expected RSTD for the DL positioning resources from the plurality of SVs and at least one of the elevation angle of each of the plurality of SVs and an Earth orbit of each of the plurality of SVs, or a combination thereof; and measure the DL positioning resources using the prioritization for the DL positioning resources.

In one implementation, a method performed by a location server for supporting positioning of a user equipment (UE) in a non-terrestrial network, the method includes generating a prioritization for downlink (DL) positioning resources from a plurality of space vehicles (SVs) in the non-terrestrial network based on at least one of expected reference signal time differences (RSTD) for a plurality of DL positioning resources at least one of an elevation angle of each of the plurality of SVs and an Earth orbit of each of the plurality of SVs, or a combination thereof; sending positioning assistance data for the DL positioning resources to the UE including the prioritization of the DL positioning resources.

In one implementation, a location server configured for supporting positioning of a user equipment (UE) in a non-terrestrial network, includes an external interface configured to wirelessly communicate with entities in the non-terrestrial network; at least one memory; and at least one processor coupled to the external interface and the at least one memory and configured to: generate a prioritization for downlink (DL) positioning resources from a plurality of space vehicles (SVs) in the non-terrestrial network based on at least one of expected reference signal time differences (RSTD) for a plurality of DL positioning resources at least one of an elevation angle of each of the plurality of SVs and an Earth orbit of each of the plurality of SVs, or a combination thereof; send, via the external interface, positioning assistance data for the DL positioning resources to the UE including the prioritization of the DL positioning resources.

In one implementation, a location server configured for supporting positioning of a user equipment (UE) in a non-terrestrial network, includes means for generating a prioritization for downlink (DL) positioning resources from a plurality of space vehicles (SVs) in the non-terrestrial network based on at least one of expected reference signal time differences (RSTD) for a plurality of DL positioning resources at least one of an elevation angle of each of the plurality of SVs and an Earth orbit of each of the plurality of SVs, or a combination thereof; means for sending positioning assistance data for the DL positioning resources to the UE including the prioritization of the DL positioning resources.

In one implementation, a non-transitory computer-readable storage medium including program code stored thereon, the program code is operable to configure at least one processor in a location server for supporting positioning of a user equipment (UE) in a non-terrestrial network, the program code comprising instructions to: generate a prioritization for downlink (DL) positioning resources from a plurality of space vehicles (SVs) in the non-terrestrial network based on at least one of expected reference signal time differences (RSTD) for a plurality of DL positioning resources at least one of an elevation angle of each of the plurality of SVs and an Earth orbit of each of the plurality of SVs, or a combination thereof; send positioning assistance data for the DL positioning resources to the UE including the prioritization of the DL positioning resources.

In one implementation, a method performed by a location server for supporting positioning of a user equipment (UE) in a non-terrestrial network, the method includes generating a burst configuration for downlink (DL) positioning resources from a plurality of space vehicles (SVs) in the non-terrestrial network to be measured by the UE based on an orbital position of each SV with respect to an estimated position of the UE, the burst configuration comprising at least one group of DL positioning resources from different SVs that will arrive at the UE within a predetermined maximum time window; and sending the burst configuration for DL positioning resources to the UE for measurement of the DL positioning resources.

In one implementation, a location server configured for supporting positioning of a user equipment (UE) in a non-terrestrial network, includes an external interface configured to wirelessly communicate with entities in the non-terrestrial network; at least one memory; and at least one processor coupled to the external interface and the at least one memory and configured to: generate a burst configuration for downlink (DL) positioning resources from a plurality of space vehicles (SVs) in the non-terrestrial network to be measured by the UE based on an orbital position of each SV with respect to an estimated position of the UE, the burst configuration comprising at least one group of DL positioning resources from different SVs that will arrive at the UE within a predetermined maximum time window; and send, via the external interface, the burst configuration for DL positioning resources to the UE for measurement of the DL positioning resources.

In one implementation, a location server configured for supporting positioning of a user equipment (UE) in a non-terrestrial network, includes means for generating a burst configuration for downlink (DL) positioning resources from a plurality of space vehicles (SVs) in the non-terrestrial network to be measured by the UE based on an orbital position of each SV with respect to an estimated position of the UE, the burst configuration comprising at least one group of DL positioning resources from different SVs that will arrive at the UE within a predetermined maximum time window; and means for sending the burst configuration for DL positioning resources to the UE for measurement of the DL positioning resources.

In one implementation, a non-transitory computer-readable storage medium including program code stored thereon, the program code is operable to configure at least one processor in a location server for supporting positioning of a user equipment (UE) in a non-terrestrial network, the program code comprising instructions to: generate a burst configuration for downlink (DL) positioning resources from a plurality of space vehicles (SVs) in the non-terrestrial network to be measured by the UE based on an orbital position of each SV with respect to an estimated position of the UE, the burst configuration comprising at least one group of DL positioning resources from different SVs that will arrive at the UE within a predetermined maximum time window; and send the burst configuration for DL positioning resources to the UE for measurement of the DL positioning resources.

In one implementation, a method performed by a location server for supporting positioning of a user equipment (UE) in a non-terrestrial network, the method includes receiving a capability message from the UE, the capability message indicating a first maximum search window and first uncertainty that the UE can support for the non-terrestrial network and a second maximum search window and second uncertainty that the UE can support for a terrestrial network; generating a configuration for downlink (DL) positioning resources from a plurality of space vehicles (SVs) in the non-terrestrial network to be measured by the UE based on the first maximum search window and first uncertainty that the UE can support for the non-terrestrial network; and sending the configuration for DL positioning resources to the UE for measurement of the DL positioning resources.

In one implementation, a location server configured for supporting positioning of a user equipment (UE) in a non-terrestrial network, includes an external interface configured to wirelessly communicate with entities in the non-terrestrial network; at least one memory; and at least one processor coupled to the external interface and the at least one memory and configured to: receive, via the external interface, a capability message from the UE, the capability message indicating a first maximum search window and first uncertainty that the UE can support for the non-terrestrial network and a second maximum search window and second uncertainty that the UE can support for a terrestrial network; generate a configuration for downlink (DL) positioning resources from a plurality of space vehicles (SVs) in the non-terrestrial network to be measured by the UE based on the first maximum search window and first uncertainty that the UE can support for the non-terrestrial network; and send, via the external interface, the configuration for DL positioning resources to the UE for measurement of the DL positioning resources.

In one implementation, a location server configured for supporting positioning of a user equipment (UE) in a non-terrestrial network, includes means for receiving a capability message from the UE, the capability message indicating a first maximum search window and first uncertainty that the UE can support for the non-terrestrial network and a second maximum search window and second uncertainty that the UE can support for a terrestrial network; means for generating a configuration for downlink (DL) positioning resources from a plurality of space vehicles (SVs) in the non-terrestrial network to be measured by the UE based on the first maximum search window and first uncertainty that the UE can support for the non-terrestrial network; and means for sending the configuration for DL positioning resources to the UE for measurement of the DL positioning resources.

In one implementation, a non-transitory computer-readable storage medium including program code stored thereon, the program code is operable to configure at least one processor in a location server for supporting positioning of a user equipment (UE) in a non-terrestrial network, the program code comprising instructions to: receive a capability message from the UE, the capability message indicating a first maximum search window and first uncertainty that the UE can support for the non-terrestrial network and a second maximum search window and second uncertainty that the UE can support for a terrestrial network; generate a configuration for downlink (DL) positioning resources from a plurality of space vehicles (SVs) in the non-terrestrial network to be measured by the UE based on the first maximum search window and first uncertainty that the UE can support for the non-terrestrial network; and send the configuration for DL positioning resources to the UE for measurement of the DL positioning resources.

### BRIEF DESCRIPTION OF THE DRAWINGS

FIG. 1 shows a diagram of a communication system with a non-terrestrial network architecture having transparent space vehicles (SVs) capable of supporting positioning of a user equipment (UE).

FIG. 2 shows a diagram of a communication system with a non-terrestrial network architecture having regenerative SVs capable of supporting positioning of a user equipment.

FIG. 3 shows a diagram of a communication system with a non-terrestrial network architecture having regenerative SVs and a split satellite Node B (gNB) architecture capable of supporting positioning of a user equipment.

FIG. 4A illustrates SVs simultaneously transmitting positioning signals from different distances to a UE.

FIG. 4B illustrates the arrival times at the UE for the positioning signals transmitted by the SVs in FIG. 4A.

FIG. 5A illustrates an example of a discontinuous measurement gap set pattern that may be used to manage propagation delay differences in positioning signals from SVs.

FIG. 5B illustrates another example of a discontinuous measurement gap set pattern that may be used to manage propagation delay differences in positioning signals from SVs.

FIG. 6 illustrates an example of a burst configuration of positioning signals from SVs used to manage propagation delay differences in positioning signals from SVs.

FIG. 7A illustrates a terrestrial network base station and cell and the received signal strength for a positioning signal from the base station as a function of distance from the center of the cell.

FIG. 7B illustrates a non-terrestrial network SV and beam footprint and the received signal strength for a positioning signal from the SV as a function of distance from the center of the beam footprint.

FIG. 8 is a diagram illustrating an example of a hardware implementation of UE configured to support positioning of the UE using a non-terrestrial network as discussed herein.

FIG. 9 is a diagram illustrating an example of a hardware implementation of a location server configured to support positioning of the UE using a non-terrestrial network as discussed herein.

FIG. 10 is a diagram illustrating an example of a hardware implementation of a satellite node B (gNB) configured to support positioning of the UE using a non-terrestrial network as discussed herein.

FIG. 11 shows a flowchart of an example procedure performed by a UE for supporting positioning of a UE in a non-terrestrial network.

FIG. 12 shows a flowchart of an example procedure performed by a network entity, such as a location server or gNB, for supporting positioning of a UE in a non-terrestrial network.

FIG. 13 shows a flowchart of an example procedure performed by a UE for supporting positioning of a UE in a non-terrestrial network.

FIG. 14 shows a flowchart of an example procedure performed by a location server for supporting positioning of a UE in a non-terrestrial network.

FIG. 15 shows a flowchart of an example procedure performed by a location server for supporting positioning of a UE in a non-terrestrial network.

FIG. 16 shows a flowchart of an example procedure performed by a location server for supporting positioning of a UE in a non-terrestrial network.

Like reference symbols in the various drawings indicate like elements, in accordance with certain example implementations. In addition, multiple instances of an element may be indicated by following a first number for the element with a letter or a hyphen and a second number. For example, multiple instances of an element 102 may be indicated as 102-1, 102-2, 102-3 etc. When referring to such an element using only the first number, any instance of the element is to be understood (e.g. element 102 in the previous example would refer to elements 102-1, 102-2, 102-3).

### DETAILED DESCRIPTION

Space vehicles (SVs), such as communication satellites or other similar platforms, may be used in communication systems, for example, using gateways and one or more SVs to relay communication signals between the gateways and one or more UEs. A UE, for example, may access an SV (instead of a terrestrial base station) which may be connected to an earth station (ES), which is also referred to as a ground station or Non-Terrestrial Network (NTN) Gateway. The earth station in turn would connect to an element in a 5G Network such as a modified base station (without a terrestrial antenna) or a network node in a 5G Core Network (5GCN). This element would in turn provide access to other elements in the 5G Network and ultimately to entities external to the 5G Network such as Internet web servers and other user devices.

A rationale for 5G (or other cellular network) SV, e.g., satellite, access for UEs may include ubiquitous outdoor coverage for both users and Mobile Network Operators (MNOs). For example, in many countries, including the United States, unavailable or poor cellular coverage is a common problem. Moreover, cellular access is not always possible even when there is normally good cellular coverage. For example, cellular access may be hampered due to congestion, physical obstacles, a local cellular outage caused by weather (e.g. a hurricane or tornado), or a local power outage. Satellite access to cellular networks could provide a new independent access potentially available everywhere outdoors. Current satellite capable phones, particularly for low Earth orbit (LEO) SVs, may be of similar size to a cellular smartphone and, thus, mobile NR support with satellite capable phones need not produce a significant increase in the size of phones. Moreover, satellite capable smartphones may help drive handset sales, and may add revenue for carriers. Potential users, for example, may include anyone with limited or no cellular access, anyone wanting a backup to a lack of cellular access, and anyone involved in public safety or who otherwise needs (nearly) 100% reliable mobile communication. Additionally, some users may desire an improved or more reliable E911 service, e.g., for a medical emergency or vehicle trouble in remote areas.

The use of 5G SV, e.g., satellite, access may provide other benefits. For example, 5G SV access may reduce Mobile Network Operator (MNO) infrastructure cost. For example, an MNO may use SV access to reduce terrestrial base stations, such as NR NodeBs, also referred to as gNBs, and backhaul deployment in sparsely populated areas. Further, 5G SV access may be used to overcome internet blockage, e.g., in certain countries. Additionally, 5G SV access may provide diversification to Space Vehicle Operators (SVOs). For example, 5G NR SV access could provide another revenue stream to SVOs who would otherwise provide fixed Internet access.

5G satellite access for UEs is being defined by the Third Generation Partnership Project (3GPP) in Release 17. A non-terrestrial network may use a transparent payload or a regenerative payload. With a transparent payload, radio frequency filtering, frequency conversion and amplification are employed, and accordingly, the waveform signal repeated by the payload is un-changed. With a regenerative payload, radio frequency filtering, frequency conversion and amplification as well as demodulation/decoding, switch and/or routing, coding/modulation is employed, and is effectively equivalent to having all or part of the base station functions (e.g. gNB) on board the SV.

Different types of NTN (SV) platforms, which includes high-altitude pseudo satellite (HAPS), may have different distances, and hence signal delays and coverage, on the Earth. The maximum and minimum propagation delay contributions to the round trip delay for SVs in different orbits may have large differences relative to the typical propagation delay found in a Terrestrial Network (TN), which is on the order of microseconds. For example, in some cases, the difference between the maximum and minimum propagation delay contributions to the round trip delay for NTN SVs may be on the order of milliseconds. This relatively large propagation delay difference found in NTN platforms may impact position measurements. For example, a UE served by satellite S1 in a LEO may also be within coverage of an incoming satellite S2 also in LEO. The UE may perform measurements of the neighboring cells originating from satellite S2 for mobility purposes based on the measurement configuration provided to the UE. However, the propagation delay difference from the UE to satellite S1 and the UE to satellite S2 may vary significantly. If the Synchronization Signal block (SSB)/Physical Broadcast Channel (PCBH) block measurement timing configuration (SMTC) measurement gap configuration does not consider the propagation delay difference, the UE may miss the SSB/Channel State Information-Reference Signal (CSI-RS) measurement window and will thus be unable to perform measurements on the configured reference signals. Similar issues may likewise arise in positioning measurements where the expected reference signal time difference (RSTD) differences are very different and gap durations are small.

Various implementations may be used to mitigate the effects on the propagation delay differences of positioning signals transmitted by SVs in a NTN, as described herein. For example, in some implementations, the UE may be configured with a discontinuous measurement gap set for each positioning occasion that includes separate measurement gaps that the UE uses to receive positioning signals transmitted by different SVs. The separation between the measurement gaps in the discontinuous measurement gap set may be configured, e.g. based on the expected propagation delays due to the SV orbit, elevation angle, etc.

In some implementations, a prioritization of the positioning signals may be configured based on, e.g., the expected reference signal time differences (RSTD). The prioritization may be generated by the UE based on the expected RSTD received from a location server or by the location server and provided to the UE. The UE may measure the positioning signals based on the prioritization. The UE may further report location information based on the prioritization.

In some implementations, the burst configuration of positioning signals may be configured for different SVs based on the orbital position of the SVs. The burst configuration is configured, for example, so that the positioning signals from different SVs, e.g., in different orbital positions, will arrive at the UE within a maximum time window.

In some implementations, the UE may provide a capability message to the location server indicating the maximum search window and uncertainty that the UE supports for positioning using non-terrestrial networks. The UE may also provide an indication of the maximum search window and uncertainty supported for terrestrial networks. The maximum search window and uncertainty for positioning using non-terrestrial networks may be used to configure the positioning signals from different SVs to be measured by the UE.

Various additions to the above implementations and alternative implementations are discussed herein.

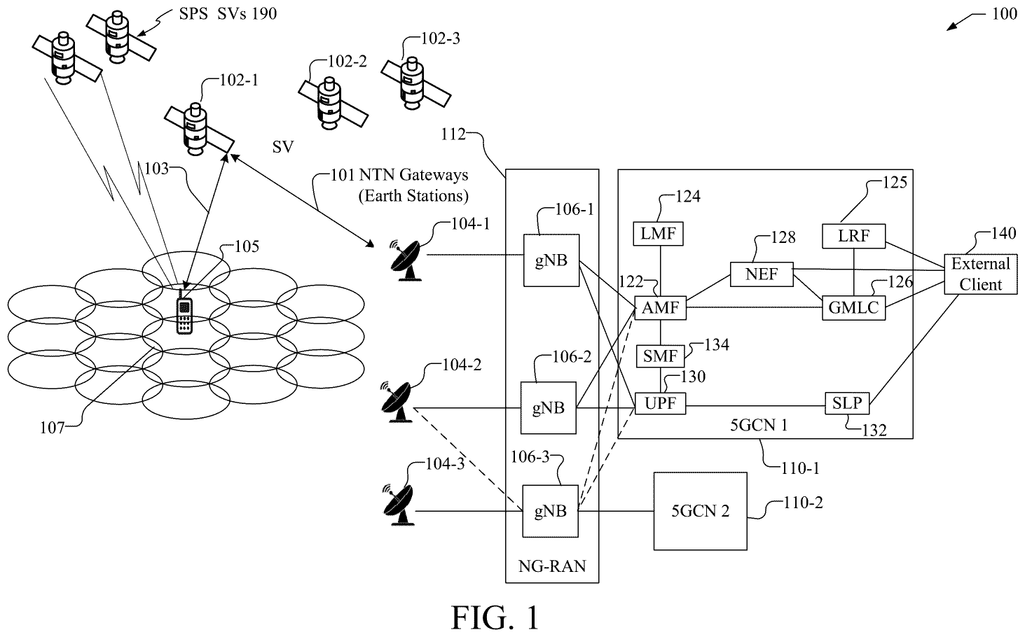

FIG. 1 illustrates an example network architecture 100 capable of supporting SV access and positioning of a UE, as discussed herein. FIG. 1 illustrates a network architecture with transparent space vehicles (SVs). The network architecture 100 illustrated in FIG. 1 is based on SVs with a transparent payload, e.g., in which, a transparent SV may implement radio frequency (RF) filtering, frequency conversion and amplification in both uplink (UL) and downlink (DL) directions and may correspond to an analog RF repeater. A transparent SV, for example, may receive uplink (UL) signals from all served UEs and may redirect the combined signals DL to an earth station without demodulating or decoding the signals. Similarly, a transparent SV may receive an UL signal from an earth station and redirect the signal DL to served UEs without demodulating or decoding the signal. However, the SV may frequency convert received signals and may amplify and/or filter received signals before transmitting the signals.

The network architecture 100 illustrates a UE 105, an SV 102-1 to 102-3 (collectively referred to herein as SVs 102), a number of Non-Terrestrial Network (NTN) gateways 104-1 to 104-3 (collectively referred to herein as NTN gateways 104) (sometimes referred to herein simply as gateways 104, earth stations 104, or ground stations 104), a number of NR NodeBs (gNBs) 106-1 to 106-3 (collectively referred to herein as gNBs 106) capable of communication with UEs via SVs 102 and that are part of a Next Generation (NG) Radio Access Network (RAN) (NG-RAN) 112. The SV 102-1 is wireless coupled to the Earth station 104-1 via a feeder link 101 and wireless coupled to the UE 105 via a service link 103. The UE 105 is illustrated as located within a beam footprint 107 of the SV 102-1. It is noted that the term gNB refers in general to an enhanced gNB with support for SVs and may be referred to as a gNB (e.g. in 3GPP) or sometimes may be referred to as a satellite NodeBs (sNBs). The network architecture 100 is illustrated as further including components of a number of Fifth Generation (5G) networks including 5G Core Networks (5GCNs) 110-1 and 110-2 (collectively referred to herein as 5GCNs 110). The 5GCNs 110 may be public land mobile networks (PLMN) that may be located in the same or in different countries. FIG. 1 illustrates various components within 5GCN1 110-1 that may operate with the NG-RAN 112. It should be understood that 5GCN2 110-2 and other 5GCNs may include identical, similar or different components and associated NG-RANs, which are not illustrated in FIG. 1 in order to avoid unnecessary obfuscation. A 5G network may also be referred to as a New Radio (NR) network; NG-RAN 112 may be referred to as a 5G RAN or as an NR RAN; and 5GCN 110 may be referred to as an NG Core network (NGC).

The network architecture 100 may further utilize information from space vehicles (SVs) 190 for Satellite Positioning System (SPS) including Global Navigation Satellite Systems (GNSS) like Global Positioning System (GPS), GLObal NAvigation Satellite System (GLONASS), Galileo or Beidou or some other local or regional SPS, such as Indian Regional Navigation Satellite System (IRNSS), European Geostationary Navigation Overlay Service (EGNOS), or Wide Area Augmentation System (WAAS), all of which are sometimes referred to herein as GNSS. It is noted that SVs 190 act as navigation SVs and are separate and distinct from SVs 102, which act as communication SVs. However, it is not precluded that some of SVs 190 may also act as some of SVs 102 and/or that some of SVs 102 may also act as some of SVs 190. In some implementations, for example, the SVs 102 may be used for both communication and positioning. Additional components of the network architecture 100 are described below. The network architecture 100 may include additional or alternative components.

Permitted connections in the network architecture 100 having the network architecture with transparent SVs illustrated in FIG. 1, allow a gNB 106 to access multiple Earth stations 104 and/or multiple SVs 102. A gNB 106, e.g., illustrated by gNB 106-3, may also be shared by multiple PLMNs (5GCNs 110), which may all be in the same country or possibly in different countries, and an Earth station 104, e.g., illustrated by Earth station 104-2, may be shared by more than one gNB 106.

It should be noted that FIG. 1 provides only a generalized illustration of various components, any or all of which may be utilized as appropriate, and each of which may be duplicated or omitted, as necessary. Specifically, although only three UEs 105 are illustrated, it will be understood that many UEs (e.g., hundreds, thousands, millions, etc.) may utilize the network architecture 100. Similarly, the network architecture 100 may include a larger (or smaller) number of SVs 190, SVs 102, earth stations 104, gNBs 106, NG-RAN 112, 5GCNs 110, external clients 140, and/or other components. The illustrated connections that connect the various components in the network architecture 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, 4G Long Term Evolution (LTE), etc.

The UE 105 may comprise and/or be referred to as a device, a mobile device, a wireless device, a mobile terminal, a terminal, a mobile station (MS), a Secure User Plane Location (SUPL) Enabled Terminal (SET), or by some other name. Moreover, UE 105 may correspond to a cellphone, smartphone, laptop, tablet, PDA, consumer tracking device, consumer navigation device, Internet of Things (IoT) device, or some other portable or moveable device. Typically, though not necessarily, the UE 105 may support wireless communication using one or more Radio Access Technologies (RATs) such as using Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G New Radio (NR) (e.g., using the NG-RAN 112 and 5GCN 140), etc. The UE 105 may also support wireless communication using a Wireless Local Area Network (WLAN) which may connect to other networks (e.g. the Internet) using a Digital Subscriber Line (DSL) or packet cable for example. The UE 105 further supports wireless communications using space vehicles, such as SVs 102. The use of one or more of these RATs may allow the UE 105 to communicate with an external client 140 (via elements of 5GCN 110 not shown in FIG. 1, or possibly via a Gateway Mobile Location Center (GMLC) 126).

The UE 105 may include a single entity or may include multiple entities such as in a personal area network where a user may employ audio, video and/or data I/O devices and/or body sensors and a separate wireline or wireless modem.

The UE 105 may support position determination, e.g., using signals and information from space vehicles 190 in an SPS, such as GPS, GLONASS, Galileo or Beidou or some other local or regional SPS such as IRNSS, EGNOS or WAAS, all of which may be generally referred to herein as GNSS. Position measurements using SPS are based on measurements of propagation delay times of SPS signals broadcast from a number of orbiting SVs to a SPS receiver in the UE 105. Once the SPS receiver has measured the signal propagation delays for each SV, the range to each SV can be determined and precise navigation information including 3-dimensional position, velocity, and time of day of the SPS receiver can then be determined using the measured ranges and the known locations of the SVs. Positioning methods which may be supported using SVs 190 may include Assisted GNSS (A-GNSS), Real Time Kinematic (RTK), Precise Point Positioning (PPP) and Differential GNSS (DGNSS). Information and signals from SVs 102 may also be used to support positioning. The UE 105 may further support positioning using terrestrial positioning methods, such as Observed Time Difference of Arrival (OTDOA), Enhanced Cell ID (ECID), Round Trip signal propagation Time (RTT), multi-cell RTT, angle of arrival (AOA), angle of departure (AOD), time of arrival (TOA), receive-transmit transmission-time difference (Rx-Tx) and/or other positioning methods. It is noted that the terms “position method” and “positioning method” can be synonymous and can be used interchangeably.

An estimate of a location of the UE 105 may be referred to as a geodetic location, location, location estimate, location fix, fix, position, position estimate or position fix, and may be geographic, thus providing location coordinates for the UE 105 (e.g., latitude and longitude) which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geographically or in civic form) within which the UE 105 is expected to be located with some probability or confidence level (e.g., 67%, 95%, etc.) A location of the UE 105 may further be a relative location comprising, for example, a distance and direction or relative X, Y (and Z) coordinates defined relative to some origin at a known location which may be defined geographically, in civic terms, or by reference to a point, area, or volume indicated on a map, floor plan or building plan. In the description contained herein, the use of the term location may comprise any of these variants unless indicated otherwise. When computing the location of a UE, it is common to solve for local x, y, and possibly z coordinates and then, if needed, convert the local coordinates into absolute ones (e.g. for latitude, longitude and altitude above or below mean sea level).

The UEs 105 are configured to communicate with 5GCNs 110 via the SVs 102, earth stations 104, and gNBs 106. As illustrated by NG-RAN 112, the NG-RANs associated with the 5GCNs 110 may include one or more gNBs 106. The NG-RAN 112 may further include a number of terrestrial base stations, e.g., gNBs (not shown) that are not capable of communication with UEs via SVs 102 (not shown). Pairs of terrestrial and/or satellite base stations, e.g., gNBs and gNB 106-1 in NG-RAN 112 may be connected to one another using terrestrial links—e.g. directly or indirectly via other gNBs or gNBs 106 and communicate using an Xn interface. Access to the 5G network is provided to UEs 105 via wireless communication between each UE 105 and a serving gNB 106, via an SV 102 and an earth station 104. The gNBs 106 may provide wireless communications access to the 5GCN 110 on behalf of each UE 105 using 5G NR. 5G NR radio access may also be referred to as NR radio access or as 5G radio access and may be as defined by the Third Generation Partnership Project (3GPP).

Base stations (BSs) in the NG-RAN 112 shown in FIG. 1 may also or instead include a next generation evolved Node B, also referred to as an ng-eNB. An ng-eNB may be connected to one or more gNBs 106 and/or gNBs in NG-RAN 112—e.g. directly or indirectly via other gNBs 106, gNBs and/or other ng-eNBs. An ng-eNB may provide LTE wireless access and/or evolved LTE (eLTE) wireless access to a UE 105.

A gNB 106 may be referred to by other names such as a gNB or a “satellite node” or “satellite access node.” The gNBs 106 are not the same as terrestrial gNBs, but may be based on a terrestrial gNB with additional capability. For example, a gNB 106 may terminate the radio interface and associated radio interface protocols to UEs 105 and may transmit DL signals to UEs 105 and receive UL signals from UEs 105 via SVs 102 and earth stations (ESs) 104. A gNB 106 may also support signaling connections and voice and data bearers to UEs 105 and may support handover of UEs 105 between different radio cells for the same SV 102, between different SVs 102 and/or between different gNBs 106. In some systems, a gNB 106 may be referred to as a gNB or as an enhanced gNB. The gNBs 106 may be configured to manage moving radio beams (for LEO SVs) and associated mobility of UEs 105. The gNBs 106 may assist in the handover (or transfer) of SVs 102 between different Earth stations 104, different gNBs 106, and between different countries. The gNBs 106 may hide or obscure specific aspects of connected SVs 102 from the 5GCN 110, e.g. by interfacing to a 5GCN 110 in the same way or in a similar way to a gNB, and may avoid a 5GCN 110 from having to maintain configuration information for SVs 102 or perform mobility management related to SVs 102. The gNBs 106 may further assist in sharing of SVs 102 over multiple countries. The gNBs 106 may communicate with one or more earth stations 104, e.g., as illustrated by gNB 106-2 communicating with earth stations 104-2 and 104-1. The gNBs 106 may be separate from earth stations 104, e.g., as illustrated by gNBs 106-1 and 106-2, and earth stations 104-1 and 104-2. The gNBs 106 may include or may be combined with one or more earth stations 104, e.g., using a split architecture. For example, with a split architecture, a gNB 106 may include a Central Unit and an earth station may act as Distributed Unit (DU). A gNB 106 may typically be fixed on the ground with transparent SV operation. In one implementation, one gNB 106 may be physically combined with, or physically connected to, one earth station 104 to reduce complexity and cost.

The earth stations 104 may be shared by more than one gNB 106 and may communicate with UE 105 via the SVs 102. An earth station 104 may be dedicated to just one SVO and to one associated constellation of SV 102 and hence may be owned and managed by the SVO. Earth stations 104 may be included within a gNB 106, e.g., as a gNB-DU within a gNB 106, which may occur when the same SVO or the same MNO owns both the gNB 106 and the included earth stations 104. Earth stations 104 may communicate with SVs 102 using control and user plane protocols that may be proprietary to an SVO. The control and user plane protocols between earth stations 104 and SVs 102 may: (i) establish and release Earth Station 104 to SV 102 communication links, including authentication and ciphering; (ii) update SV software and firmware; (iii) perform SV Operations and Maintenance (O&M); (iv) control radio beams (e.g., direction, power, on/off status) and mapping between radio beams and earth station uplink (UL) and downlink (DL) payload; and (v) assist with handoff of an SV 102 or radio cell to another Earth station 104.

As noted, while FIG. 1 depicts nodes configured to communicate according to 5G NR and LTE communication protocols for an NG-RAN 112, nodes configured to communicate according to other communication protocols may be used, such as, for example, an LTE protocol for an Evolved Universal Mobile Telecommunications System (UMTS) Terrestrial Radio Access Network (E-UTRAN) or an IEEE 802.11x protocol for a WLAN. For example, in a 4G Evolved Packet System (EPS) providing LTE wireless access to UE 105, a RAN may comprise an E-UTRAN, which may comprise base stations comprising evolved Node Bs (eNBs) supporting LTE wireless access. A core network for EPS may comprise an Evolved Packet Core (EPC). An EPS may then comprise an E-UTRAN plus EPC, where the E-UTRAN corresponds to NG-RAN 112 and the EPC corresponds to 5GCN 110 in FIG. 1. The methods and techniques described herein for support of a RAN location server function may be applicable to such other networks.

The gNBs 106 in the NG-RAN 112 may communicate with the AMF 122 in a 5GCN 110, which, for positioning functionality, may communicate with a Location Management Function (LMF) 124. For example, the gNBs 106 may provide an N2 interface to the AMF 122. An N2 interface between a gNB 106 and a 5GCN 110 may be the same as an N2 interface supported between a gNB and a 5GCN 110 for terrestrial NR access by a UE 105 and may use the Next Generation Application Protocol (NGAP) defined in 3GPP Technical Specification (TS) 38.413 between a gNB 106 and the AMF 122. The AMF 122 may support mobility of the UE 105, including radio cell change and handover and may participate in supporting a signaling connection to the UE 105 and possibly data and voice bearers for the UE 105. The LMF 124 may support positioning of the UE 105 when UE accesses the NG-RAN 112 and may support position procedures/methods such as A-GNSS, OTDOA, RTK, PPP, DGNSS, ECID, AOA, AOD, multi-cell RTT and/or other positioning procedures including positioning procedures based on communication signals from one or more SVs 102. The LMF 124 may also process location services requests for the UE 105, e.g., received from the AMF 122 or from a Gateway Mobile Location Center (GMLC) 126. The LMF 124 may be connected to AMF 122 and/or to GMLC 126. In some embodiments, a node/system that implements the LMF 124 may additionally or alternatively implement other types of location-support modules, such as an Enhanced Serving Mobile Location Center (E-SMLC). It is noted that in some embodiments, at least part of the positioning functionality (including derivation of a UE 105's location) may be performed at the UE 105 (e.g., using signal measurements obtained by UE 105 for signals transmitted by SVs 102, SVs 190, gNBs and assistance data provided to the UE 105, e.g. by LMF 124).

The GMLC 126 may support a location request for the UE 105 received from an external client 140 and may forward such a location request to the AMF 122 for forwarding by the AMF 122 to the LMF 124. A location response from the LMF 124 (e.g. containing a location estimate for the UE 105) may be similarly returned to the GMLC 126 via the AMF 122, and the GMLC 126 may then return the location response (e.g., containing the location estimate) to the external client 140. The GMLC 126 is shown connected to only the AMF 122 in FIG. 1 though in some implementations may be connected to both the AMF 122 and the LMF 124 and may support direct communication between the GMLC 126 and LMF 124 or indirection communications, e.g. via the AMF 122.

A Network Exposure Function (NEF) 128 may be included in 5GCN 110, e.g., connected to the GMLC 126 and the AMF 122. In some implementations, the NEF 128 may be connected to communicate directly with the external client 140. The NEF 128 may support secure exposure of capabilities and events concerning 5GCN 110 and UE 105 to an external client 140 and may enable secure provision of information from external client 140 to 5GCN 110.

A User Plane Function (UPF) 130 may support voice and data bearers for UE 105 and may enable UE 105 voice and data access to other networks such as the Internet. The UPF 130 may be connected to gNBs 106 and gNBs. UPF 130 functions may include: external Protocol Data Unit (PDU) session point of interconnect to a Data Network, packet (e.g. Internet Protocol (IP)) routing and forwarding, packet inspection and user plane part of policy rule enforcement, Quality of Service (QoS) handling for user plane, downlink packet buffering and downlink data notification triggering. UPF 130 may be connected to a Secure User Plane Location (SUPL) Location Platform (SLP) 132 to enable support of positioning of UE 105 using SUPL. SLP 132 may be further connected to or accessible from external client 140.

As illustrated, a Session Management Function (SMF) 134 connects to the AMF 122 and the UPF 130. The SMF 134 may have the capability to control both a local and a central UPF within a PDU session. SMF 134 may manage the establishment, modification, and release of PDU sessions for UE 105, perform IP address allocation and management for UE 105, act as a Dynamic Host Configuration Protocol (DHCP) server for UE 105, and select and control a UPF 130 on behalf of UE 105.

The external client 140 may be connected to the core network 110 via the GMLC 126 and/or the SLP 132, and in some implementations, the NEF 128. The external client 140 may optionally be connected to the core network 110 and/or to a location server, which may be, e.g., an SLP, that is external to 5GCN 110, via the Internet. The external client 140 may be connected to the UPF 130 directly (not shown in FIG. 1) or through the Internet. The external client 140 may be a server, a web server, or a user device, such as a personal computer, a UE, etc.

A Location Retrieval Function (LRF) 125 may be connected to the GMLC 126, as illustrated, and in some implementations, to the SLP 132, as defined in 3GPP Technical Specifications (TSs) 23.271 and 23.167. LRF 125 may perform the same or similar functions to GMLC 126, with respect to receiving and responding to a location request from an external client 140 that corresponds to a Public Safety Answering Point (PSAP) supporting an emergency call from UE 105. One or more of the GMLC 126, LRF 125, and SLP 132 may be connected to the external client 140, e.g., through another network, such as the Internet.

The AMF 122 may normally support network access and registration by UEs 105, mobility of UEs 105, including radio cell change and handover and may participate in supporting a signaling connection to a UE 105 and possibly data and voice bearers for a UE 105. The role of an AMF 122 may be to Register the UE during a Registration process, as discussed herein. The AMF 122 may page the UE 105, e.g., by sending a paging message via one or more radio cells in the tracking area in which the UE 105 is located.

Network architecture 100 may be associated with or have access to space vehicles (SVs) 190 for a Global Navigation Satellite System (GNSS) like GPS, GLONASS, Galileo or Beidou or some other local or regional Satellite Positioning System (SPS) such as IRNSS, EGNOS or WAAS. UEs 105 may obtain location measurements for signals transmitted by SVs 190 and/or by base stations and access points such as eNBs, ng-eNB, gNB, and/or SVs 102 which may enable a UE 105 to determine a location estimate for UE 105 or to obtain a location estimate for UE 105 from a location server in 5GCN 110, e.g., LMF 124. For example, UE 105 may transfer location measurements to the location server to compute and return the location estimate. UEs 105 (or the LMF 124) may obtain a location estimate for UE 105 using position methods such as GPS, Assisted GPS (A-GPS), Assisted GNSS (A-GNSS), Observed Time Difference of Arrival (OTDOA), Enhanced Cell ID (ECID), multi-cell RTT, Wireless Local Area Network (WLAN) positioning (e.g. using signals transmitted by IEEE 802.11 WiFi access points), sensors (e.g. inertial sensors) in UE 105, or some (hybrid) combination of these. A UE 105 may use a location estimate for the UE 105 during Registration.

As noted, while the network architecture 100 is described in relation to 5G technology, the network architecture 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GCN 110 may be configured to control different air interfaces. For example, in some embodiments, 5GCN 110 may be connected to a WLAN, either directly or using a Non-3GPP InterWorking Function (N3IWF, not shown FIG. 1) in the 5GCN 110. For example, the WLAN may support IEEE 802.11 WiFi access for UE 105 and may comprise one or more WiFi APs. Here, the N3IWF may connect to the WLAN and to other elements in the 5GCN 110 such as AMF 122.

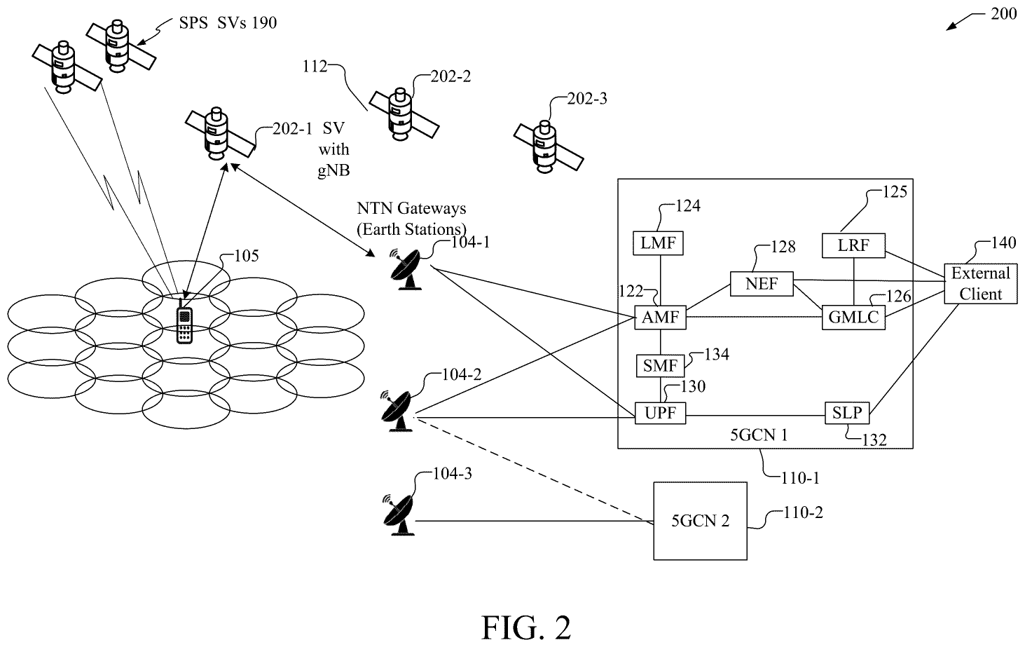

FIG. 2 shows a diagram of another example network architecture 200 capable of supporting SV access and positioning of a UE, as discussed herein. The network architecture shown in FIG. 2 is similar to that shown in FIG. 1, like designated elements being similar or the same. FIG. 2, however, illustrates a network architecture with regenerative SVs 202-1, 202-2, and 202-3 (collectively SVs 202), as opposed to transparent SVs 102 shown in FIG. 1. A regenerative SV 202 may use RF filtering, frequency conversion, and amplification, as well as demodulation/decoding, switch and/or routing, and coding/modulation. This is effectively equivalent to having all or part of base station functions (e.g. gNB) on board the SV 202. Thus, a regenerative SV 202, unlike a transparent SV 102, includes an on-board gNB 202 (e.g. includes the functional capability of a gNB), and may sometimes referred to as an SV/gNB 202. The NG-RAN 112 is illustrated as including the SV/gNBs 202. Reference to a gNB 202 is used herein when referring to SV/gNB 202 functions related to communication with UEs 105 and 5GCNs 110, whereas reference to an SV 202 is used when referring to SV/gNB 202 functions related to communication with earth stations 104 and with UEs 105 at a physical radio frequency level. However, there may be no precise delimitation of an SV 202 versus a gNB 202.

An onboard gNB 202 may perform many of the same functions as a gNB 106 as described previously. For example, a gNB 202 may terminate the radio interface and associated radio interface protocols to UEs 105 and may transmit DL signals to UEs 105 and receive UL signals from UEs 105, which may include encoding and modulation of transmitted signals and demodulation and decoding of received signals. A gNB 202 may also support signaling connections and voice and data bearers to UEs 105 and may support handover of UEs 105 between different radio cells for the same gNB 202 and between different gNBs 202. The gNBs 202 may assist in the handover (or transfer) of SVs 202 between different Earth stations 104, different 5GCNs 110, and between different countries. The gNBs 202 may hide or obscure specific aspects of SVs 202 from the 5GCN 110, e.g. by interfacing to a 5GCN 110 in the same way or in a similar way to a gNB. The gNBs 202 may further assist in sharing of SVs 202 over multiple countries. The gNBs 202 may communicate with one or more earth stations 104 and with one or more 5GCNs 110 via the earth stations 104. In some implementations, gNBs 202 may communicate directly with other gNBs 202 using Inter-Satellite Links (ISLs) (not shown in FIG. 2), which may support an Xn interface between any pair of gNBs 202.

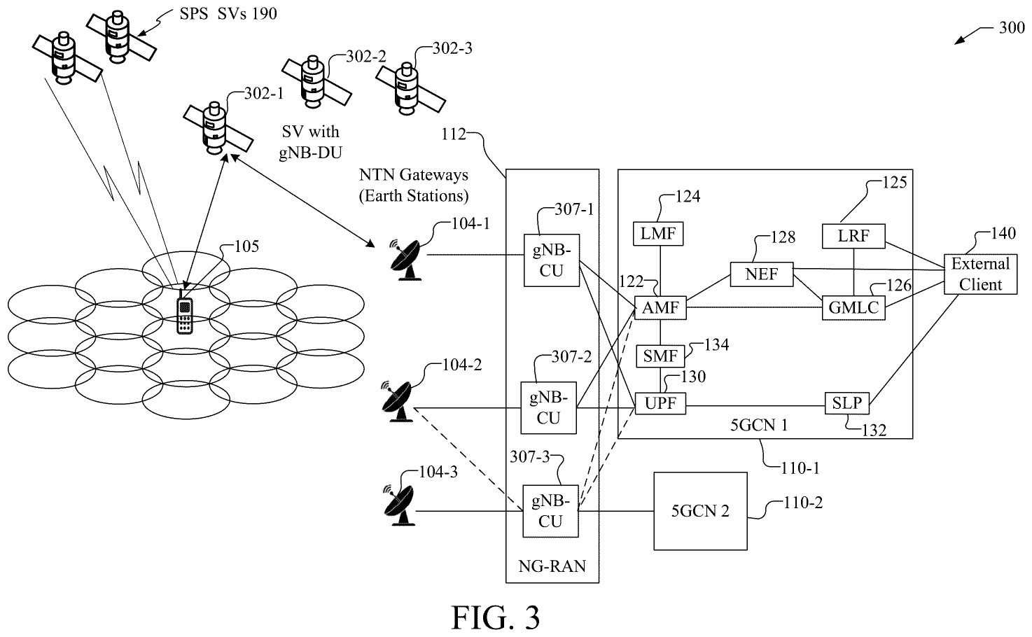

FIG. 3 shows a diagram of another example network architecture 200 capable of supporting SV access and positioning of a UE, as discussed herein. The network architecture shown in FIG. 3 is similar to that shown in FIGS. 1 and 2, like designated elements being similar or the same. FIG. 3, however, illustrates a network architecture with regenerative SVs 302-1, 302-2, and 302-3 (collectively referred to as SVs 302), as opposed to transparent SVs 102 shown in FIG. 1, and with a split architecture for the gNBs. The gNBs 307 include a central unit and may sometimes be referred as gNB-CU 307, and a regenerative SV 302, unlike a transparent SV 102, includes an on-board gNB Distributed Unit (gNB-DU) 302, and is sometimes referred to herein as an SV/gNB-DU 302. Reference to a gNB-DU 302 is used herein when referring to SV/gNB 302 functions related to communication with UEs 105 and gNB-CUs 307, whereas reference to an SV 302 is used when referring to SV/gNB-DU 302 functions related to communication with earth stations 104 and with UEs 105 at a physical radio frequency level. However, there may be no precise delimitation of an SV 302 versus a gNB-DU 302.

Each gNB-DU 302 communicates with one ground based gNB-CU 307 via one or more earth stations 104. One gNB-CU 307 together with the one or more gNB-DUs 302 which are in communication with the gNB-CU 307 performs functions, and may use internal communication protocols, which are similar to or the same as a gNB with a split architecture as described in 3GPP TS 38.401. Here a gNB-DU 302 corresponds to and performs functions similar to or the same as a gNB Distributed Unit (gNB-DU) defined in TS 38.401, while a gNB-CU 307 corresponds to and performs functions similar to or the same as a gNB Central Unit (gNB-CU) defined in TS 38.401. For example, a gNB-DU 302 and a gNB-CU 307 may communicate with one another using an F1 Application Protocol (F1AP) as defined in 3GPP TS 38.473 and together may perform some or all of the same functions as a gNB 106 or gNB 202 as described previously. To simplify references to different types of gNB is the description below, a gNB-DU 302 may sometimes be referred to a gNB 302 (without the “DU” label), and a gNB-CU 307 may sometimes be referred to a gNB 307 (without the “CU” label).

A gNB-DU 302 may terminate the radio interface and associated lower level radio interface protocols to UEs 105 and may transmit DL signals to UEs 105 and receive UL signals from UEs 105, which may include encoding and modulation of transmitted signals and demodulation and decoding of received signals. A gNB-DU 302 may support and terminate Radio Link Control (RLC), Medium Access Control (MAC) and Physical (PHY) protocol layers for the NR Radio Frequency (RF) interface to UEs 105, as defined in 3GPP TSs 38.201, 38.202, 38.211, 38.212, 38.213, 38.214, 38.215, 38.321 and 38.322. The operation of a gNB-DU 302 is partly controlled by the associated gNB-CU 307. One gNB-DU 307 may support one or more NR radio cells for UEs 105. A gNB-CU 307 may support and terminate a Radio Resource Control (RRC) protocol, Packet Data Convergence Protocol (PDCP) and Service Data Protocol (SDAP) for the NR RF interface to UEs 105, as defined in 3GPP TSs 38.331, 38.323, and 37.324, respectively. A gNB-CU 307 may also be split into separate control plane (gNB-CU-CP) and user plane (gNB-CU-UP) portions, where a gNB-CU-CP communicates with one or more AMFs 122 in one more 5GCNs 110 using the NGAP protocol and where a gNB-CU-UP communicates with one or more UPFs 130 in one more 5GCNs 110 using a General Packet Radio System (GPRS) tunneling protocol (GTP) user plane protocol (GTP-U) as defined in 3GPP TS 29.281. A gNB-DU 302 and gNB-CU 307 may communicate over an F1 interface to (a) support control plane signaling for a UE 105 using Internet Protocol (IP), Stream Control Transmission Protocol (SCTP) and F1 Application Protocol (F1AP) protocols, and (b) to support user plane data transfer for a UE using IP, User Datagram Protocol (UDP), PDCP, SDAP, GTP-U and NR User Plane Protocol (NRUPP) protocols.

A gNB-CU 307 may communicate with one or more other gNB-CUs 307 and/or with one more other gNBs using terrestrial links to support an Xn interface between any pair of gNB-CUs 302 and/or between any gNB-CU 307 and any gNB.

A gNB-DU 302 together with a gNB-CU 307 may: (i) support signaling connections and voice and data bearers to UEs 105; (ii) support handover of UEs 105 between different radio cells for the same gNB-DU 302 and between different gNB-DUs 302; and (iii) assist in the handover (or transfer) of SVs 302 between different Earth stations 104, different 5GCNs 110, and between different countries. A gNB-CU 307 may hide or obscure specific aspects of SVs 302 from a 5GCN 110, e.g. by interfacing to a 5GCN 110 in the same way or in a similar way to a gNB. The gNB-CUs 307 may further assist in sharing of SVs 302 over multiple countries.

SVs in NTNs may be located in different orbits, including Low-Earth Orbit (LEO), Medium-Earth Orbit (MEO), Geostationary-Earth Orbit (GEO), High Elliptical Orbit (HEO), etc. Consequently, different NTN platforms may have significantly different distances from the SVs (including high-altitude pseudo satellite (HAPS)) to the Earth. Table 1, for example, illustrates various NTN platforms, along with distances to Earth and typical coverage area.

TABLE 1

| | | | | Typical Beam | |
|---|---|---|---|---|---|
| Platform | Altitude Range | | Orbit | Footprint Size | |
| Low-Earth Orbit | 300-1500 | km | Circular around | 100-1000 | km |
| (LEO) satellite | | | the Earth | | |
| Medium-Earth | 7000-25,000 | km | | 100-1000 | km |
| Orbit (MEO) | | | | | |
| satellite | | | | | |
| Geostationary- | 35,786 | km | Notional station | 200-3500 | km |
| Earth Orbit | | | keeping position | | |
| (GEO) satellite | | | fixed in terms of | | |
| Pseudo Satellites | 8-50 km (2 km | | elevation/azimuth | 5-200 | km |
| including High- | for HAPS) | | with respect to a | | |
| Altitude Pseudo | | | given Earth point | | |
| Satellite (HAPS) | | | | | |
| High Elliptical | 400-50,000 | km | Elliptical around | 200-3500 | km |
| Orbit (HEO) | | | the Earth | | |
| satellite | | | | | |

Wireless signals are transmitted at a fixed speed (speed of light), and thus, the propagation times from SVs in different orbits (and/or elevation angles) may have significantly different delays. Moreover, as illustrated in Table 1, the beam footprint for SVs in different orbits may significantly differ. Table 2 illustrates propagation delays for various NTN scenarios versus delay constraints.

TABLE 2

| | A | B | C1 | C2 | D1 | D2 |
|---|---|---|---|---|---|---|
| | GEO | GEO | LEO | | LEO | |
| | Trans- | Regen- | Trans- | | Regen- | |
| | parent | erative | parent | | erative | |
| NTN Scenarios | Payload | Payload | Payload | | Payload | |
| Satellite Altitude | 35,786 km | | 600 km | | | |
| Min Elevation for | 10° for service link and 10° for feeder link | | | | | |
| Both Feeder and | | | | | | |
| Service Links | | | | | | |
| Typical Min/Max | 100 km/3500 km | | 50 km/1000 km | | | |
| NTN Beam | | | | | | |
| Footprint | | | | | | |
| Diameter | | | | | | |
| (NOTE 1) | | | | | | |
| Max Propagation | 541.46 ms | 270.73 ms | 25.77 ms | | 12.89 ms | |
| Delay | (Worst | | | | | |
| Contribution to | Case) | | | | | |
| the Round Trip | | | | | | |
| Delay on the | | | | | | |
| Radio Interface | | | | | | |
| between the | | | | | | |
| gNB and the UE | | | | | | |
| Min Propagation | 477.48 ms | 238.74 ms | 8 ms | | 4 ms | |
| Delay | | | | | | |
| Contribution to | | | | | | |
| the Round Trip | | | | | | |
| Delay on the | | | | | | |
| Radio Interface | | | | | | |
| between the | | | | | | |
| gNB and the UE | | | | | | |
| Max Round Trip | Negligible | | Up to ±93.0 | | Up to ±47.6 | |
| Delay Variation | | | μs/sec (Worst | | μs/sec | |
| as seen by the UE | | | Case) | | | |
| (NOTE 2) | | | | | | |

1: The beam footprint diameters are indicative. The diameter depends on the orbit, earth latitude, antenna design, and radio resource management strategy in a given system
2: The delay variation measures how fast the round trip delay (function of UE-satellite-NTN gateway distance) varies over time. The worst case is when the satellite moves towards/away from the UE at 10° elevation angle, assuming the UE speed is 1200 km/h. It is expressed in μs/sec and is negligible for GEO scenario.
3: Speed of light used for delay calculation is 299792458 m/s.

As can be seen by the maximum and minimum propagation delay contributions to the round trip delay, GEO and LEO NTN platforms may have large propagation differences, relative to the typical propagation delay found in a Terrestrial Network (TN), which is on the order of microseconds. For example, GEO case A has a propagation difference of 542−477=65 ins, GEO case B has a propagation difference of 270−238=32 ms, LEO case C1/C2 has a propagation difference of 25−8=17 ms, and LEO case D1/D2 has a propagation difference of 13−4=7 ms.

The relatively large propagation delay difference found in NTN platforms may impact position measurements. For example, a UE that is served by a LEO satellite S1, may also be within coverage of an incoming LEO satellite S2. The UE may perform measurements of the neighboring cells originating from S2 for mobility purposes based on the measurement configuration provided to the UE. However, the propagation delay difference from the UE to satellite S1 and the UE to satellite S2 may vary significantly. If the Synchronization Signal block (SSB)/Physical Broadcast Channel (PCBH) block measurement timing configuration (SMTC) measurement gap configuration does not consider the propagation delay difference, the UE may miss the SSB/Channel State Information-Reference Signal (CSI-RS) measurement window and will thus be unable to perform measurements on the configured reference signals. This challenge is captured for both GEO and LEO scenarios and is to be addressed with priority for LEO scenarios.

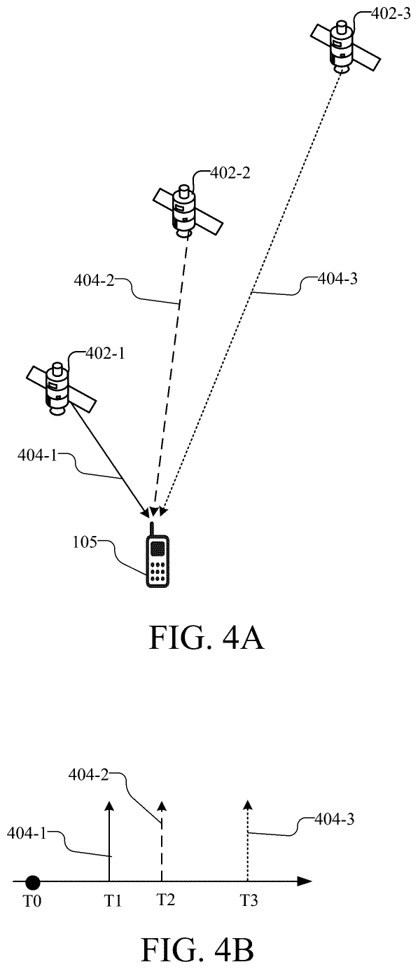

FIG. 4A, for example, illustrates a scenario in which three SVs 402-1, 402-2, and 402-3 (sometimes collectively referred to as SVs 402) are at significantly different distances to the UE 105. The SVs 402-1, 402-2, and 402-3, for example, may be any of SVs 102-1, 202-1, and 302-1, and may be in different orbits, such as LEO, MEO, and HEO, respectively, or may be in a similar orbit but at a significantly different elevation relative to the UE 105. For the sake of example, the three SVs 402-1, 402-2, and 402-3 may transmit DL positioning signal 404-1, 404-2, and 404-3, respectively, to the UE 105, e.g., broadcasted signals intended for all the UE within the coverage region, at precisely the same time. The NTN SV transmissions may be defined as one of the positioning frequency layer in the LPP specification 3GPP TS 38.355. Due to the very large differences in the distance between each SV 402 and the UE 105, the propagation delay for each transmitted DL positioning signal will significantly differ.

FIG. 4B, for example, graphically illustrates the simultaneous time of transmission TO and the different times of reception T1, T2, and T3 of the DL positioning signals 404-1, 404-2, and 404-3 that is due to the signal propagation delay caused by the differing distances between the UE 105 and the SVs 402-1, 402-2, and 402-3.

There may be instances in which the UE 105 performing NTN positioning measurement will use measurement gaps. If measurement gaps are necessary for the NTN positioning measurement, a conventional measurement gaps supported by Release 16 cannot accommodate the large propagation delay differences from the NTN SVs 402. For example, the maximum measurement gap supported in Release 16 is 10 ms with 80 ms periodicity or 20 ms with 160 ms periodicity. As discussed above, however, the propagation delay difference found in GEO and LEO SVs may be up to 65 ms.

Similar issues will likewise arise in positioning measurements where the expected reference signal time difference (RSTD) differences are very different and gap durations are small. A UE 105, for example, may be provided with the expected RSTD value together with uncertainty (search space window) for DL PRS from the transmission reception points (TRPs) in the assistance data. The value range of the expected RSTD for NTN SVs may be ±500 μs. On the other hand, for TN TRPs, the value range for the uncertainty of the expected RSTD when any of the resources used for the DL positioning measurement are in FR1 may be ±32 μs, and in FR2 may be ±8 μs.

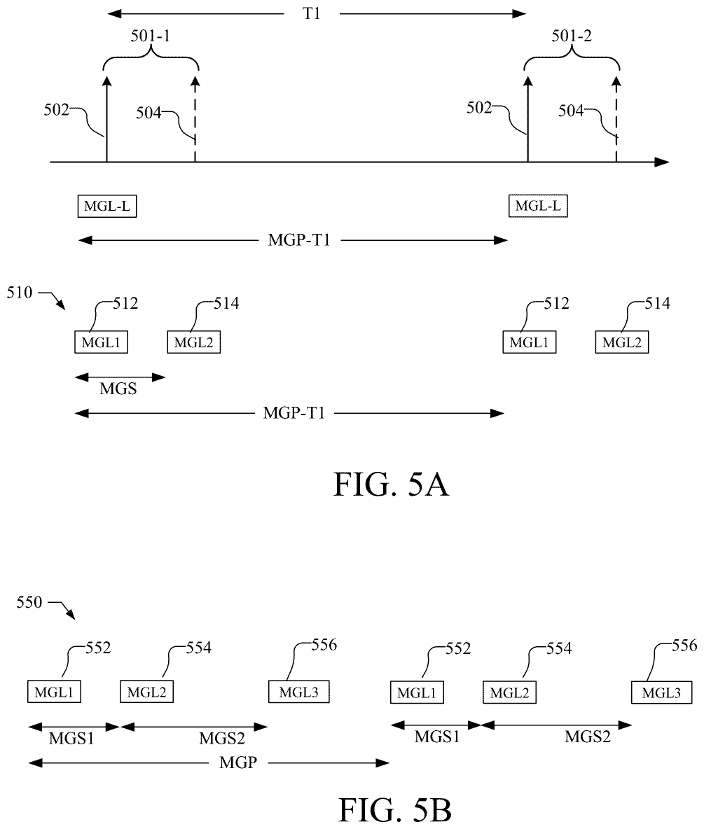

FIG. 5A graphically illustrates examples of measurement gap patterns that may be used to manage propagation delay differences in positioning signals from NTN SVs. FIG. 5A illustrates the periodic positioning occasions, illustrated by occasions 501-1 and 501-2 (sometimes collectively referred to as positioning occasion(s) 501) that include two NTN positioning signals 502 and 504, e.g., DL PRS with a PRS periodicity T1 between each positioning occasion 501. The two NTN positioning signals 502 and 504 are received by a UE at significantly different times, as discussed above, and accordingly, the use of a legacy measurement gap (e.g., a measurement gap supported by Release 16) will not enable the capture of both positioning signals by the UE. For example, FIG. 5A illustrates a legacy measurement gap MGL-L, with a periodicity of MGP-T1 (corresponding to the positioning occasion period T1), which has a duration defined in Release 16 of e.g., 10 ms or 20 ms, which is too short to capture both NTN positioning signals 502 and 504, which may have a propagation delay difference of up to 65 ms.

As illustrated in FIG. 5A, the UE may be configured with a discontinuous measurement gap set 510 for each positioning occasion 501 for processing the positioning signals 502 and 504 from NTN SVs. The discontinuous measurement gap set 510 associated with each occasion 501 include at least two discontinuous, i.e., separated, measurement gaps that are repeated with a periodicity that is the same as the periodicity of the positioning occasions. Thus, as illustrated in FIG. 5A, the discontinuous measurement gap set 510 associated with each occasion 501 includes multiple measurement gaps 512 and 514 with measurement gap lengths MGL1 and MGL2, respectively, that are discontinuous, e.g., separated by a measurement gap separation MGS1, and are repeated with a periodicity of MGP-T1 (corresponding to the positioning occasion period T1). Each measurement gap 512 and 514 within the measurement gap set 510 is associated with an NTN positioning signal 502 and 504 from a different NTN SV. The measurement gap lengths of the measurement gaps in the discontinuous measurement gap set 510, e.g., MGL1 and MGL2, may be the same or different. The separation MGS between the measurement gaps 512 and 514, thus, may be based at least partially on the estimated propagation delay of the NTN positioning signal 502 and 504 to the UE, and thus is based at least partially on an estimated distance between the NTN SV and the UE, which may be a function of the orbits and/or elevation angles of the NTN SVs. For example, the separation MGS may be determined by a location server based at least partially on the orbit and/or elevation angle of the NTN SVs and provided to the UE in positioning assistance data.

For example, 3GPP TS 37.355 provides configurations that are sent to the UE for UE-based GNSS, which may be used to derive the orbital information. By way of example, a GNSS Orbit Model can be given in Keplerian parameters or as state vector in Earth-Centered Earth-Fixed coordinates, dependent on the GNSS-ID and the target device capabilities. Other constellations of SVs may have other types of representations. Accordingly, based on the provided orbit model and approximate location of the UE, an estimated distance between the NTN SVs and the UE may be determined, from which the parameters of the discontinuous measurement gap, e.g., MGL and MGS, may be determined.

The UE 105, for example, may request measurement gaps for positioning measurements in a NTN from a network entity, such as a location server or gNB. The network entity may configure the discontinuous measurement gap set with multiple separate measurement gaps based at least in part on the expected propagation delay between the transmitting NTN SVs and the UE. The UE 105 may receive the discontinuous measurement gap set 510, and receive the NTN positioning signals 502 and 504 using the multiple gaps 512 and 514, respectively, in each positioning occasion 501 and performs positioning measurements using the NTN positioning signals 502 and 504. The UE may generate location information based on the positioning measurements, e.g., a position estimate or the positioning measurements, which may be transmitted to the location server.

FIG. 5B graphically illustrates another example of a discontinuous measurement gap set 550 that includes more than two measurement gaps to receive and perform positioning measurements of a corresponding number of NTN positioning signals. As illustrated in FIG. 5B, the discontinuous measurement gap set 550 includes measurement gaps 552, 554, and 556, with measurement gap lengths MGL1, MGL2, and MGL3, which may same or one or more may differ. The measurement gaps 552, 554, 556 are discontinuous, e.g., separated by a measurement gap separation MGS1 and MGS2 and are repeated with a periodicity MGP (corresponding to the periodicity of the periodicity of the associated positioning occasion). The measurement gap separation MGS1 and MGS2 may be the same or one may differ, and as discussed above, may be determined by a location server based at least partially on the orbit and/or elevation angle of the NTN SVs and provided to the UE in positioning assistance data. As illustrated in FIG. 5B, the measurement gap separations MGS1 and MGS2 are illustrated with respect to the immediately preceding measurement gap, but in some implementations, the measurement gap separations may be with respect to a single measurement gap, e.g., the first measurement gap 552.

In another implementation, longer measurement gaps may be used for NTN positioning. Due to the larger propagation delay difference on measurements that may occur in NTN positioning, it may not be possible to decode the positioning resources from different SVs using single measurement gap with a conventional measurement gap length, e.g., as supported in Release 16 is 10 ms with 80 ms periodicity or 20 ms with 160 ms periodicity. Accordingly, in some implementations, a longer measurement gap length may be used for NTN positioning, such as a measurement gap length of 40 msec, 80 msec, or 160 msec.

In some implementations, the location server, e.g., LMF 124, may design or select the NTN positioning signal configurations to be measured by a UE 105 such that the NTN positioning signals from different NTN SVs, e.g., at different orbits and/or elevation angles, arrive at the UE 105 at nearly the same time, e.g., in a burst within predetermined maximum time window.

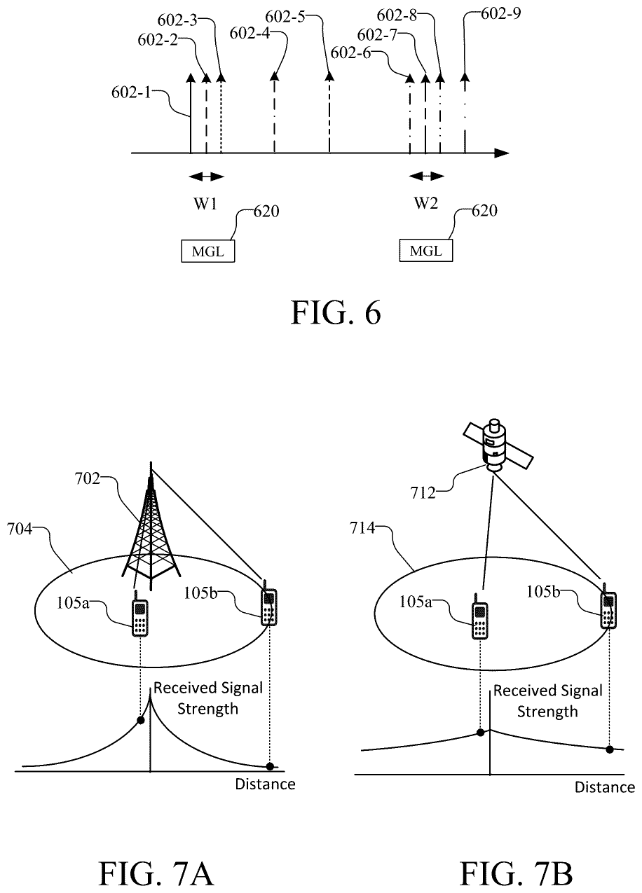

FIG. 6 graphically illustrates examples of a plurality of NTN positioning signals 602-1, 602-2, 602-3, 602-4, 602-5, 602-6, 602-7, 602-8, 602-9 (sometimes collectively referred to as NTN positioning signals 602) from different NTN SVs, as received by the UE 105 along a timeline. As illustrated, NTN positioning signals 602-1, 602-2, and 602-3 arrive within a burst window W1 and NTN positioning signals 602-6, 602-7 and 602-8 arrive within a burst window W2. For the sake of example, the burst windows W1 and W2 are able to be received within a legacy measurement gap 620 having measurement gap length MGL. The NTN positioning signals 602-4, 602-5, and 602-9 will not be received by the UE 105 within a predetermined maximum time window, and thus are not included in the burst windows W1 or W2. The predetermined maximum time window may be similar to what is used in conventional terrestrial networks for Uu interfaces, FR1 may be ±32 μs, and in FR2 may be ±8 μs. Using these parameters reduces the memory requirements in the UE 105 and improves processing capabilities, as receiving positioning resources over a larger uncertainty window requires additional processing power.

In some implementations, the UE 105 may provide an indication, e.g., in a capabilities message, of the maximum number of SVs in a group that the UE 105 can support. For example, because each SV will have its own propagation delay, which may differ from others, the UE 105 may need multiple measurement gaps to decode different sets of SVs that are grouped together in burst windows. The UE 105 may provide a capability message that will indicate the maximum group that the UE 105 can support for NTN positioning. Within each group, all NTN SVs may be decoded using the same gap offset and pattern. The UE 105 may further indicate how many simultaneous measurement gaps that the UE 105 can support. Within each group, all the NTN positioning signals will reach the UE within a time window, where the time window is less than the maximum measurement gap length supported in the standard.

Because the propagation delay found in a NTN system may be orders of magnitude higher than in terrestrial systems, resulting in an expected RSTD that may be in a much higher range compared to TN systems. For example, in a TN system, the search window may be a couple of resource symbols. In a NTN system, however, the search window may be up to couple of slots, e.g., where, by way of example, a typical resource frame may include ten subframes numbered, each subframe may have a duration of 1 ms and is divided into two slots each having a duration of 0.5 ms, and each slot may contain 6 or 7 modulation symbol periods (e.g., depending on the length of the cyclic prefix prepended to each symbol period).

In some implementations, the UE 105 may provide a capability message to the location server, e.g., LMF 124, with an indication that the UE 105 is capable of supporting a maximum search window and uncertainty to support positioning for an NTN network. The indication of the maximum search window and uncertainty to support positioning using a NTN network, for example, may be an indication of the number of symbols that the UE 105 can search for any positioning signal. The UE 105 may also provide a separate search window for separate platform methods, e.g., the capability message may further indicate that the UE 105 is capable of supporting a second maximum search window and second uncertainty to support positioning for a terrestrial network. The location server, e.g., LMF 124, may use the capability information to define the optimal NTN positioning signal transmission from NTN satellites, and provide the configuration to the UE for measurement.

Additionally, with an NTN system, an NTN positioning signal received by a UE 105 from an NTN SV will have approximately the same signal strength regardless of the UE 105 position within the beam footprint. In contrast, in a terrestrial network, e.g. Uu interface, the signal strength of a received positioning signal varies considerable based on position within the cell.

FIG. 7A, for example, illustrates a TN base station 702 and cell 704 and illustrates two UEs 105a and 105b. FIG. 7A further illustrates the received signal strength for a positioning signal received from the base station 702 as a function of distance from the center of the cell 704. As illustrated, the received signal strength from the base station 702 significantly varies as a function of distance over the cell 704. Accordingly, a positioning signal received from the base station 702 near the center of the cell 704, e.g., by the UE 105a, has a significantly greater signal strength than the same positioning signal received near the edge of the cell 704, e.g., by the UE 105b.

FIG. 7B is similar to FIG. 7A, but illustrates an NTN SV 712 and its beam footprint 714 and illustrates the two UEs 105a and 105b. FIG. 7B further illustrates the received signal strength for a positioning signal received from the NTN SV 712 as a function of distance from the center of the beam footprint 714. As illustrated, the received signal strength from the NTN SV 712 does not significantly vary over the beam footprint 714. Accordingly, a positioning signal received from the NTN SV 712 near the center of the beam footprint 714, e.g., by the UE 105a, has approximately the same signal strength than the same positioning signal received near the edge of the beam footprint 714, e.g., by the UE 105b.

As illustrated in FIG. 7A, in a TN system, the signal strength of a received signal may different significantly based on location within the cell. Accordingly, for a TN system, the location server may prioritize PRS to be measured by the UE 105 based on an estimated distance of the UE 105 to the base station and the received signal strength of the PRS that will be received by the UE 105. As illustrated in FIG. 7B, for an NTN system, NTN positioning signal from an NTN satellite will be received at almost same signal strength regardless of position within the beam footprint. Accordingly, the location server, e.g., LMF 124, need not prioritize based on received signal strength, but may group the NTN SVs based on expected reference signal time differences (RSTD) and may provide assistance data to the UE 105 with the expected RSTD for a number of NTN positioning resources from a number of NTN SV, and in some implementations, the elevation angle of each of the plurality of SVs. In some implementations, the location server may further provide the orbit of each NTN SV in the assistance data. The location server may provide the priority to the UE 105 for each group in positioning assistance data as well. The UE 105 may prioritize measurements of from any NTN SV within the group based on the expected RSTD and the elevation angle of each of the plurality of SVs or the orbit of the SVs, if provided in assistance data, or based on a priority provided by the location server.

In terrestrial systems, a UE 105 can determine if it is near a cell edge due to a clear difference in received signal strength as compared to the cell center, as illustrated in FIG. 7A. This effect, however, may not be as pronounced in NTN deployments, resulting in a small difference in signal strength between two beams in a region of overlap. Accordingly, the location server, e.g., LMF 124, may use different rules for measuring positioning resources for NTN methods. The signal strength may be similar for all visible SVs. Accordingly, in one implementation, the UE 105 (or LMF 124) may prioritize the NTN positioning resource based on the expected RSTD. In another option, the UE 105 (or LMF 124) may additionally or alternatively prioritize the NTN positioning resources based on the elevation angle. Elevation angles of source and target cells-based triggering: The UE 105 (or LMF 124) may additionally prioritize the NTN positioning resources based on the Earth orbit of the NTN SVs. The positioning resources, for example, may be prioritized based on different platforms, e.g., GEO vs LEO vs MEO vs HAPS vs HEO.

The UE 105 may measure the positioning resources based on the prioritization and generate a location information report that is sent to the location server. The location information may be based on the measurements of the NTN positioning resources and the prioritization of the NTN positioning resources. For example, measurement results for higher priority NTN positioning resources may be reported before measurement results for lower priority NTN positioning resources.

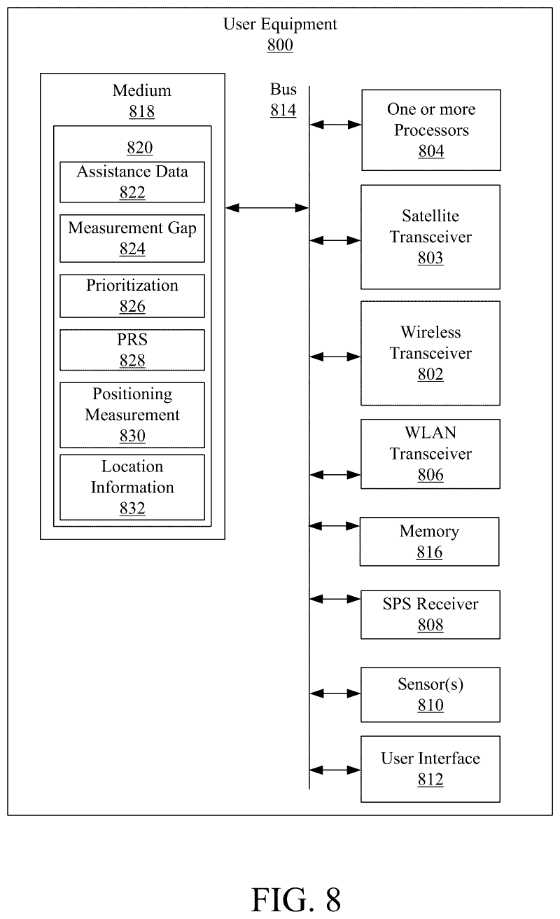

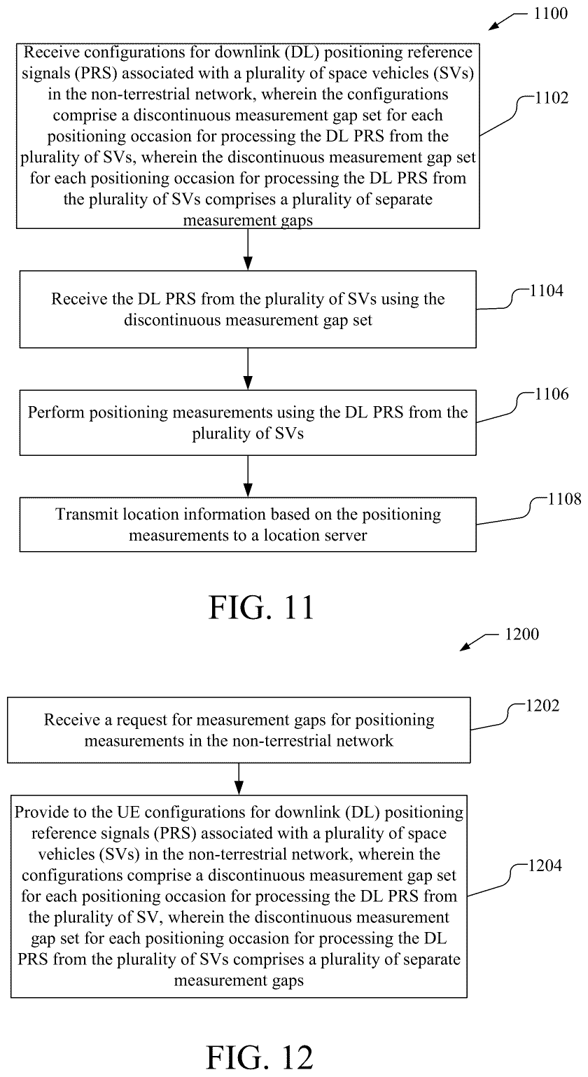

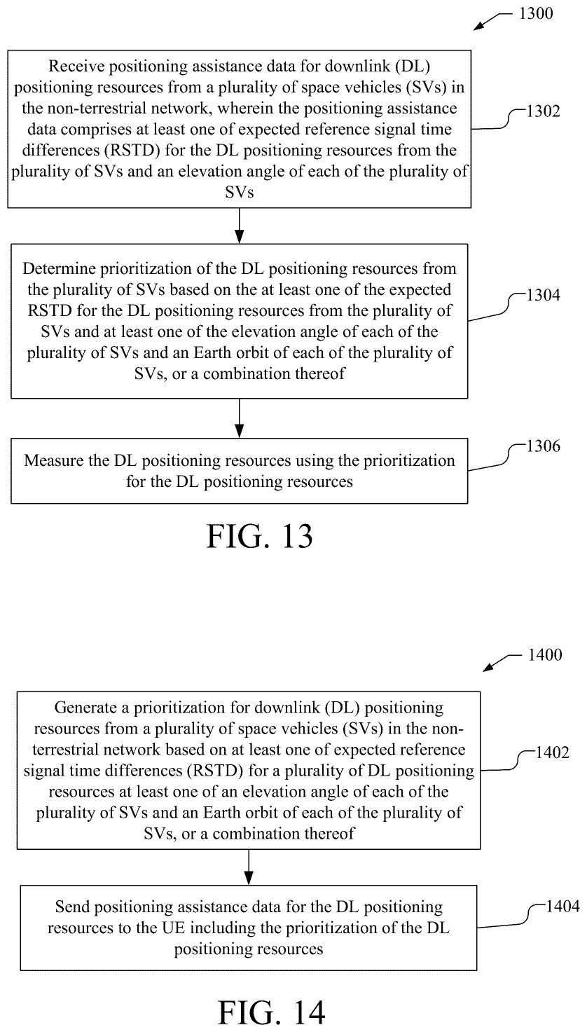

FIG. 8 is a diagram illustrating an example of a hardware implementation of UE 800, such as UE 105 shown in FIGS. 1, 2, and 3. The UE 800 may be configured to perform the positioning processes described in FIGS. 5A, 5B, 6, 7A, and 7B, the procedures 1100 and 1300 described in FIGS. 11 and 13, and related algorithms disclosed herein. The UE 800 may include, e.g., hardware components such as a satellite transceiver 803 to wirelessly communicate with an SV 102/202/302 via a wireless antenna (not shown in FIG. 8), e.g., as shown in FIGS. 1, 2, and 3. The UE 800 may further include wireless transceiver 802 to wirelessly communicate with terrestrial base stations in an NG-RAN 112 via a wireless antenna (not shown in FIG. 8), e.g., base stations such as a gNB or an ng-eNB. The UE 800 may also include additional transceivers, such a wireless local area network (WLAN) transceiver 806, as well as an SPS receiver 808 for receiving and measuring signals from SPS SVs 190 (shown in FIGS. 1, 2, and 3) via a wireless antenna (not shown in FIG. 8). In some implementations, the UE 800 may receive data from a SV, e.g., via satellite transceiver 803, and may respond to a terrestrial base station, e.g., via wireless transceiver 802, or via WLAN transceiver 806. Thus, UE 800 may include one or more transmitters, one or more receives or both, and these may be integrated, discrete, or a combination of both. The UE 800 may further include one or more sensors 810, such as cameras, accelerometers, gyroscopes, electronic compass, magnetometer, barometer, etc. The UE 800 may further include a user interface 812 that may include e.g., a display, a keypad or other input device, such as virtual keypad on the display, through which a user may interface with the UE 800. The UE 800 further includes one or more processors 804, memory 816, and non-transitory computer readable medium 818, which may be coupled together with bus 814. The one or more processors 804 and other components of the UE 800 may similarly be coupled together with bus 814, a separate bus, or may be directly connected together or coupled using a combination of the foregoing.

The one or more processors 804 may be implemented using a combination of hardware, firmware, and software. For example, the one or more processors 804 may be configured to perform the functions discussed herein by implementing one or more instructions or program code 820 on a non-transitory computer readable medium, such as medium 818 and/or memory 816. In some embodiments, the one or more processors 804 may represent one or more circuits configurable to perform at least a portion of a data signal computing procedure or process related to the operation of UE 800.

The medium 818 and/or memory 816 may store instructions or program code 1020 that contain executable code or software instructions that when executed by the one or more processors 804 cause the one or more processors 804 to operate as a special purpose computer programmed to perform the techniques disclosed herein. As illustrated in UE 800, the medium 818 and/or memory 816 may include one or more components or modules that may be implemented by the one or more processors 804 to perform the methodologies described herein. While the components or modules are illustrated as software in medium 818 that is executable by the one or more processors 804, it should be understood that the components or modules may be stored in memory 816 or may be dedicated hardware either in the one or more processors 804 or off the processors.

A number of software modules and data tables may reside in the medium 818 and/or memory 816 and be utilized by the one or more processors 804 in order to manage both communications and the functionality described herein. It should be appreciated that the organization of the contents of the medium 818 and/or memory 816 as shown in UE 800 is merely exemplary, and as such the functionality of the modules and/or data structures may be combined, separated, and/or be structured in different ways depending upon the implementation of the UE 800. While the components or modules are illustrated as software in medium 818 and/or memory 816 that is executable by the one or more processors 804, it should be understood that the components or modules may be firmware or dedicated hardware either in the one or more processors 804 or off the processors.

As illustrated, the program code 1020 stored on medium 818 and/or memory 816 may include an assistance data module 822, that when implemented by the one or more processors 804 configures the one or more processors 804 to receive, via wireless transceiver 802 or satellite transceiver 803, positioning assistance data, which may include, e.g., configurations for downlink (DL) positioning reference signals (PRS) associated with a plurality of SVs in the non-terrestrial network. The assistance data, for example, may include a discontinuous measurement gap set that includes separate measurement gaps for DL PRS from different SVs, e.g., as discussed in reference to FIGS. 5A and 5B. The discontinuous measurement gap set may have a periodicity that is the same as the periodicity of the positioning occasions. The assistance data may further include expected RSTD for DL positioning resources from the plurality of SVs, an elevation angle of each of the plurality of SVs, the orbit of the SVs, or any combination thereof.

As illustrated, the program code 1020 stored on medium 818 and/or memory 816 may include a measurement gap module 824 that when implemented by the one or more processors 804 configures the one or more processors 804 to implement measurement gaps for receiving DL PRS as discussed herein, including the discontinuous measurement gap set. The discontinuous measurement gap set, for example, may have a periodicity that is the same as the periodicity of the positioning occasions. The discontinuous measurement gap set may be configured with a plurality of separate measurement gaps and with a positioning occasion periodicity, a measurement gap length for each separate measurement gap, and a gap separation between the separate measurement gaps. The separate measurement gaps, for example, may be configured to be associated with the DL PRS from different SVs which may be in a different Earth orbits. The separate measurement gaps, for example, may be configured based on the expected propagation delay of DL PRS from each SV. The one or more processors 804, for example, may be configured to cause the wireless satellite transceiver 803 to detune from current frequency resources and tune to the frequency resources of the DL PRS to be receiving during each measurement gap.

As illustrated, the program code 1020 stored on medium 818 and/or memory 816 may include a prioritization module 826 that when implemented by the one or more processors 804 configures the one or more processors 804 to determine prioritization of the DL PRS from a plurality of SVs using, e.g., the expected RSTD and/or uncertainty for the DL PRS from the plurality of SVs, the elevation angle and/or the Earth orbit of each of the plurality of SVs, or any combination thereof. The prioritization may be determined, for example, so that DL PRS from various SVs are received near in time by the UE despite having different propagation delays due to different orbits, elevation angles, etc.

As illustrated, the program code 1020 stored on medium 818 and/or memory 816 may include an PRS module 828, that when implemented by the one or more processors 804 configures the one or more processors 804 to receive, via wireless satellite transceiver 803, DL PRS transmitted by one or more SVs in the non-terrestrial network. The one or more processors 804, for example, may be configured to use the discontinuous measurement gap set, as discussed herein, to receive the DL PRS from the SVs.

As illustrated, the program code 1020 stored on medium 818 and/or memory 816 may include positioning measurement module 830, that when implemented by the one or more processors 804 configures the one or more processors 804 to perform positioning measurements using the received DL PRS. The one or more processors 804, for example, may be configured to measure the DL positioning resources based on a prioritization of the DL PRS, as determined by the one or more processors 804 or received from a location server. The one or more processors 804, for example, may be configured to perform positioning measurements such as RSTD based on the expected RSTD and uncertainty, or other measurements, such as AoA, TOA of earliest and additional paths, line of sight (LOS)/non-LOS (NLOS) estimation, reference signal received power (RSRP), path RSRP, Rx-Tx measurements, etc. In some implementations, the one or more processors 804 may be configured to determine a position estimate based on the positioning measurements and positions of SVs.

As illustrated, the program code 1020 stored on medium 818 and/or memory 816 may include location information module 832, that when implemented by the one or more processors 804 configures the one or more processors 804 to generate and transmit location information to a location server, e.g., via wireless transceiver 802 or satellite transceiver 803. The location information, for example, may be positioning measurements and/or position estimate. The one or more processors 804 may be configured to transmit location information based on the prioritization, e.g., so that positioning measurements associated with higher priority DL PRS are sent before positioning measurements associated with lower priority DL PRS.

The methodologies described herein may be implemented by various means depending upon the application. For example, these methodologies may be implemented in hardware, firmware, software, or any combination thereof. For a hardware implementation, the one or more processors 804 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation of UE 800 involving firmware and/or software, the methodologies may be implemented with modules (e.g., procedures, functions, and so on) that perform the separate functions described herein. Any machine-readable medium tangibly embodying instructions may be used in implementing the methodologies described herein. For example, software codes may be stored in a medium 818 or memory 816 and executed by one or more processors 804, causing the one or more processors 804 to operate as a special purpose computer programmed to perform the techniques disclosed herein. Memory may be implemented within the one or processors 804 or external to the one or more processors 804. As used herein the term “memory” refers to any type of long term, short term, volatile, nonvolatile, or other memory and is not to be limited to any particular type of memory or number of memories, or type of media upon which memory is stored.

If implemented in firmware and/or software, the functions performed by UE 800 may be stored as one or more instructions or code on a non-transitory computer-readable storage medium such as medium 818 or memory 816. Examples of storage media include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data for UE 800 may be provided as signals on transmission media included in a communication apparatus. For example, a communication apparatus comprising part or all of UE 800 may include a transceiver having signals indicative of instructions and data. The instructions and data are stored on non-transitory computer readable medium 818 or memory 816, and are configured to cause the one or more processors 804 to operate as a special purpose computer programmed to perform the techniques disclosed herein. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

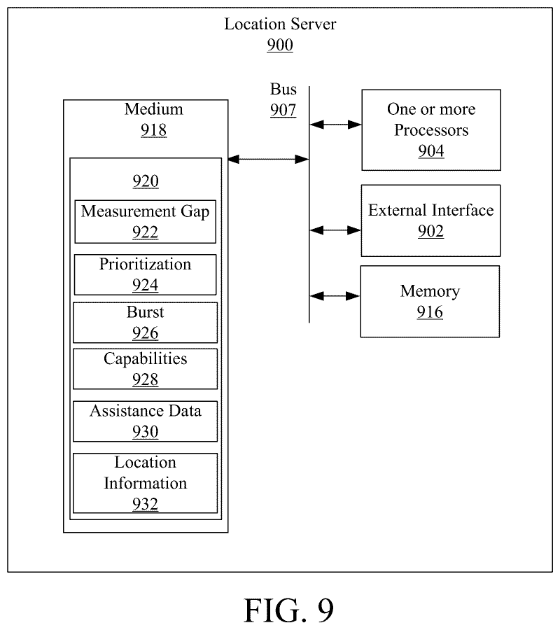

FIG. 9 is a diagram illustrating an example of a hardware implementation of a location server 900. The location server 900, for example, may be the LMF 124 shown in FIGS. 1, 2, and 3. The location server 900 may be configured to perform the positioning processes described in FIGS. 5A, 5B, 6, 7A, and 7B, the procedures 1200, 1400, 1500, and 1600 described in FIGS. 12, 14-16, and related algorithms disclosed herein. The location server 900 includes, e.g., hardware components such as an external interface 902 configured to be communication with other network components, such as the AMF 122 to communicate with UEs through a non-terrestrial network and optionally a terrestrial network. The location server 900 includes one or more processors 904, memory 916, and non-transitory computer readable medium 918, which may be coupled together with bus 907.

The one or more processors 904 may be implemented using a combination of hardware, firmware, and software. For example, the one or more processors 904 may be configured to perform the functions discussed herein by implementing one or more instructions or program code 920 on a non-transitory computer readable medium, such as medium 918 and/or memory 916. In some embodiments, the one or more processors 904 may represent one or more circuits configurable to perform at least a portion of a data signal computing procedure or process related to the operation of location server 900.

The medium 918 and/or memory 916 may store instructions or program code 920 that contain executable code or software instructions that when executed by the one or more processors 904 cause the one or more processors 904 to operate as a special purpose computer programmed to perform the techniques disclosed herein. As illustrated in location server 900, the medium 918 and/or memory 916 may include one or more components or modules that may be implemented by the one or more processors 904 to perform the methodologies described herein. While the components or modules are illustrated as software in medium 918 that is executable by the one or more processors 904, it should be understood that the components or modules may be stored in memory 916 or may be dedicated hardware either in the one or more processors 904 or off the processors.

A number of software modules and data tables may reside in the medium 918 and/or memory 916 and be utilized by the one or more processors 904 in order to manage both communications and the functionality described herein. It should be appreciated that the organization of the contents of the medium 918 and/or memory 916 as shown in location server 900 is merely exemplary, and as such the functionality of the modules and/or data structures may be combined, separated, and/or be structured in different ways depending upon the implementation of the location server 900. While the components or modules are illustrated as software in medium 918 and/or memory 916 that is executable by the one or more processors 904, it should be understood that the components or modules may be firmware or dedicated hardware either in the one or more processors 904 or off the processors.

As illustrated, the program code 920 stored on medium 918 and/or memory 916 may include a measurement gap module 922 that when implemented by the one or more processors 904 configures the one or more processors 904 to receive a request for measurement gaps from a UE, e.g., via the external interface 902, for positioning measurements in the non-terrestrial network. The one or more processors 904 may be further configured to generate a discontinuous measurement gap set for each positioning occasion for the UE to process the DL PRS from the plurality of SVs, e.g., as discussed in reference to FIGS. 5A and 5B. The discontinuous measurement gap set, for example, may have a periodicity that is the same as the periodicity of the positioning occasions. The one or more processors 904 may configure the discontinuous measurement gap set with a plurality of separate measurement gaps and with a positioning occasion periodicity, a measurement gap length for each separate measurement gap, and a gap separation between the separate measurement gaps. The separate measurement gaps, for example, may be configured to be associated with the DL PRS from different SVs which may be in a different Earth orbits. The separate measurement gaps, for example, may be configured based on the expected propagation delay of DL PRS from each SV.

As illustrated, the program code 920 stored on medium 918 and/or memory 916 may include a prioritization module 924 that when implemented by the one or more processors 904 configures the one or more processors 904 to generate a prioritization for DL PRS from a plurality of SVs in a NTN based on at least one of expected RSTD and optionally the uncertainty for a plurality of DL PRS, an elevation angle and/or Earth orbit of each of the plurality of SVs or any combination thereof. The prioritization may be determined, for example, so that DL PRS from various SVs are received near in time by the UE despite having different propagation delays due to different orbits, elevation angles, etc.

As illustrated, the program code 920 stored on medium 918 and/or memory 916 may include a burst module 926 that when implemented by the one or more processors 904 configures the one or more processors 904 to generate a burst configuration for DL PRS from a plurality of SVs in a NTN using the orbital positions of each SV with respect to an estimated position of the UE, including the Earth orbit and/or the elevation position of the satellite with respect to the UE. The one or more processors 904 may be configured to generate a burst with at least one group of DL positioning resources from different SVs that will arrive at the UE within a predetermined maximum time window, which may be e.g., the ±8 μs, ±32 μs, or within a measurement gap length, e.g. of 10 ms or 20 ms.

As illustrated, the program code 920 stored on medium 918 and/or memory 916 may include a capabilities module 928 that when implemented by the one or more processors 904 configures the one or more processors 904 to receive, via the external interface 902, a capability message from a UE, that may indicate a first maximum search window and first uncertainty that the UE can support for a non-terrestrial network and a second maximum search window and second uncertainty that the UE can support for a terrestrial network. The first maximum search window, for example, may be greater than the second maximum search window and may be a number of symbols that the UE can search for a DL positioning resource.

As illustrated, the program code 920 stored on medium 918 and/or memory 916 may include an assistance data module 930 that when implemented by the one or more processors 904 configures the one or more processors 904 to generate and send positioning assistance data for the DL PRS to the UE, via the external interface 902. The assistance data, for example, may include the discontinuous measurement gap set. The assistance data may include the prioritization information, including a prioritization or expected RSTD, uncertainty, Earth orbit, elevation angle, etc. The assistance data may include the burst configuration for the DL positioning resources. The one or more processors 904 may be configured to generate a DL PRS configuration for a plurality of SVs to be measured by the UE based on a maximum search window and uncertainty that the UE can support for an NTN.

As illustrated, the program code 920 stored on medium 918 and/or memory 916 may include a location information module 932 that when implemented by the one or more processors 904 configures the one or more processors 904 to receive, via the external interface 902, a location information report from the UE based on UE measurements of the DL PRS. The location information report may be further based on prioritization of the DL positioning resources.

The methodologies described herein may be implemented by various means depending upon the application. For example, these methodologies may be implemented in hardware, firmware, software, or any combination thereof. For a hardware implementation, the one or more processors 904 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation of location server 900 involving firmware and/or software, the methodologies may be implemented with modules (e.g., procedures, functions, and so on) that perform the separate functions described herein. Any machine-readable medium tangibly embodying instructions may be used in implementing the methodologies described herein. For example, software codes may be stored in a medium 918 or memory 916 and executed by one or more processors 904, causing the one or more processors 904 to operate as a special purpose computer programmed to perform the techniques disclosed herein. Memory may be implemented within the one or processors 904 or external to the one or more processors 904. As used herein the term “memory” refers to any type of long term, short term, volatile, nonvolatile, or other memory and is not to be limited to any particular type of memory or number of memories, or type of media upon which memory is stored.

If implemented in firmware and/or software, the functions performed by location server 900 may be stored as one or more instructions or code on a non-transitory computer-readable storage medium such as medium 918 or memory 916. Examples of storage media include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data for location server 900 may be provided as signals on transmission media included in a communication apparatus. For example, a communication apparatus comprising part or all of location server 900 may include a transceiver having signals indicative of instructions and data. The instructions and data are stored on non-transitory computer readable media, e.g., medium 918 or memory 916, and are configured to cause the one or more processors 904 to operate as a special purpose computer programmed to perform the techniques disclosed herein. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

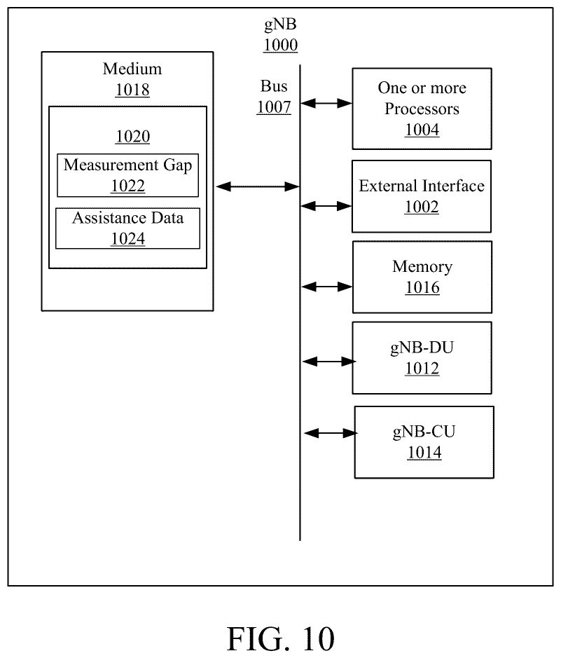

FIG. 10 is a diagram illustrating an example of a hardware implementation of a satellite node B (gNB) 1000. The gNB 1000 may correspond to any of: (i) gNB 106-1 or earth station 104-1 illustrated in FIG. 1; (ii) gNB 202 in the SV 202 illustrated in FIG. 2; or (iii) gNB-DU 302 in the SV 302 or gNB-CU 307 illustrated in FIG. 3. The gNB 1000 may be configured to perform the positioning processes described in FIGS. 5A, 5B, the procedure 1200 described in FIG. 12 and related algorithms disclosed herein. The gNB 1000 may include, e.g., hardware components such as an external interface 1002, which may comprise one or more wired and/or wireless interfaces capable of connecting to and communicating with one or more entities in a core network in a PLMN, such as AMF 122 or UPF 130 in 5GCN 110 shown in FIG. 2, and earth stations 104, as well as other gNBs, UEs 105 (e.g. when gNB 1000 is part of an SV 202 or SV 302) and to other elements in a wireless network directly or through one or more intermediary networks and/or one or more network entities, as shown in FIGS. 1, 2, and 3. The external interface 1002 may include one or more antennas to support a wireless interface and/or a wireless backhaul to elements in the wireless network. The gNB 1000 further includes one or more processors 1004, memory 1016, and non-transitory computer readable medium 1018, which may be coupled together with bus 1007. The gNB 1000 is illustrated as including a gNB-DU 10 10 and/or gNB-CU 1014 (e.g. in the case that gNB 1000 corresponds to gNB 106-3 in FIG. 1 or corresponds to gNB 202 in FIG. 2 with gNB 202 comprising a gNB-CU and one or more gNB-DUs), which may be hardware components or implemented by specifically configured one or more processors 1004. gNB-DU 1010 and gNB-CU 1014 may not be present when gNB 1000 itself corresponds to a gNB-DU (e.g. gNB-DU 302) or to a gNB-CU (e.g. gNB-CU 307).

The one or more processors 1004 may be implemented using a combination of hardware, firmware, and software. For example, the one or more processors 1004 may be configured to perform the functions discussed herein by implementing one or more instructions or program code 1020 on a non-transitory computer readable medium, such as medium 1018 and/or memory 1016. In some embodiments, the one or more processors 1004 may represent one or more circuits configurable to perform at least a portion of a data signal computing procedure or process related to the operation of gNB 1000.

The medium 1018 and/or memory 1016 may store instructions or program code 1020 that contain executable code or software instructions that when executed by the one or more processors 1004 cause the one or more processors 1004 to operate as a special purpose computer programmed to perform the techniques disclosed herein. As illustrated in gNB 1000, the medium 1018 and/or memory 1016 may include one or more components or modules that may be implemented by the one or more processors 1004 to perform the methodologies described herein. While the components or modules are illustrated as software in medium 1018 that is executable by the one or more processors 1004, it should be understood that the components or modules may be stored in memory 1016 or may be dedicated hardware either in the one or more processors 1004 or off the processors.

A number of software modules and data tables may reside in the medium 1018 and/or memory 1016 and be utilized by the one or more processors 1004 in order to manage both communications and the functionality described herein. It should be appreciated that the organization of the contents of the medium 1018 and/or memory 1016 as shown in gNB 1000 is merely exemplary, and as such the functionality of the modules and/or data structures may be combined, separated, and/or be structured in different ways depending upon the implementation of the gNB 1000. While the components or modules are illustrated as software in medium 1018 and/or memory 1016 that is executable by the one or more processors 1004, it should be understood that the components or modules may be firmware or dedicated hardware either in the one or more processors 1004 or off the processors.

As illustrated, the program code 1020 stored on medium 1018 and/or memory 1016 may include a measurement gap module 1022 that when implemented by the one or more processors 1004 configures the one or more processors 1004 to receive a request for measurement gaps from a UE, e.g., via the external interface 1002, for positioning measurements in the non-terrestrial network. The one or more processors 1004 may be further configured to generate a discontinuous measurement gap set for each positioning occasion for the UE to process the DL PRS from the plurality of SVs, e.g., as discussed in reference to FIGS. 5A and 5B. The discontinuous measurement gap set, for example, may have a periodicity that is the same as the periodicity of the positioning occasions. The one or more processors 1004 may configure the discontinuous measurement gap set with a plurality of separate measurement gaps and with a positioning occasion periodicity, a measurement gap length for each separate measurement gap, and a gap separation between the separate measurement gaps. The separate measurement gaps, for example, may be configured to be associated with the DL PRS from different SVs which may be in a different Earth orbits. The separate measurement gaps, for example, may be configured based on the expected propagation delay of DL PRS from each SV.

As illustrated, the program code 1020 stored on medium 1018 and/or memory 1016 may include an assistance data module 1024 that when implemented by the one or more processors 1004 configures the one or more processors 1004 to generate and send positioning assistance data for the DL PRS to the UE, via the external interface 1002. The assistance data, for example, may include the discontinuous measurement gap set.

The methodologies described herein may be implemented by various means depending upon the application. For example, these methodologies may be implemented in hardware, firmware, software, or any combination thereof. For a hardware implementation, the one or more processors 1004 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation of gNB 1000 involving firmware and/or software, the methodologies may be implemented with modules (e.g., procedures, functions, and so on) that perform the separate functions described herein. Any machine-readable medium tangibly embodying instructions may be used in implementing the methodologies described herein. For example, software codes may be stored in a medium 1018 or memory 1016 and executed by one or more processors 1004, causing the one or more processors 1004 to operate as a special purpose computer programmed to perform the techniques disclosed herein. Memory may be implemented within the one or processors 1004 or external to the one or more processors 1004. As used herein the term “memory” refers to any type of long term, short term, volatile, nonvolatile, or other memory and is not to be limited to any particular type of memory or number of memories, or type of media upon which memory is stored.

If implemented in firmware and/or software, the functions performed by gNB 1000 may be stored as one or more instructions or code on a non-transitory computer-readable storage medium such as medium 1018 or memory 1016. Examples of storage media include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data for gNB 1000 may be provided as signals on transmission media included in a communication apparatus. For example, a communication apparatus comprising part or all of gNB 1000 may include a transceiver having signals indicative of instructions and data. The instructions and data are stored on non-transitory computer readable media, e.g., medium 1018 or memory 1016, and are configured to cause the one or more processors 1004 to operate as a special purpose computer programmed to perform the techniques disclosed herein. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

FIG. 11 shows a flowchart of an example procedure 1100 for supporting positioning of a UE in a non-terrestrial network, performed by a user equipment (e.g., a UE 105 and UE 800).

As illustrated, at block 1102, the UE receives configurations for downlink (DL) positioning reference signals (PRS) associated with a plurality of SVs in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of satellite vehicles comprises a plurality of separate measurement gaps, e.g., as discussed in in reference to FIGS. 5A and 5B. In some implementations, each positioning occasion may be repeated with a first periodicity and the discontinuous measurement gap set may be repeated with the first periodicity, e.g., as discussed in reference to FIGS. 5A and 5B. A means for receiving configurations for downlink (DL) positioning reference signals (PRS) associated with a plurality of SVs in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of satellite vehicles comprises a plurality of separate measurement gaps may be, e.g., the wireless transceiver 802 and one or more processors 804 with dedicated hardware or implementing executable code or software instructions in memory 816 and/or medium 818, such as the assistance data module 822, in UE 800 in FIG. 8.

At block 1104, the UE receives the DL PRS from the plurality of SVs using the discontinuous measurement gap set, as discussed in reference to FIGS. 5A and 5B. A means for receiving the DL PRS from the plurality of SVs using the discontinuous measurement gap set may be, e.g., the wireless transceiver 802 and one or more processors 804 with dedicated hardware or implementing executable code or software instructions in memory 816 and/or medium 818, such as the measurement gap module 824 and the PRS module 828, in UE 800 in FIG. 8.

At block 1106, the UE performs positioning measurements using the DL PRS from the plurality of SVs, e.g., as discussed in reference to FIGS. 5A and 5B. A means for performing positioning measurements using the DL PRS from the plurality of SVs may be, e.g., the one or more processors 804 with dedicated hardware or implementing executable code or software instructions in memory 816 and/or medium 818, such as the positioning measurement module 830, in UE 800 in FIG. 8.

At block 1108, the UE transmits location information based on the positioning measurements to a location server, e.g., as discussed in reference to FIGS. 5A and 5B. A means for transmitting location information based on the positioning measurements to a location server may be, e.g., the wireless transceiver 802 and one or more processors 804 with dedicated hardware or implementing executable code or software instructions in memory 816 and/or medium 818, such as the location information module 832, in UE 800 in FIG. 8.

In some implementations, for example, the at least two measurement gaps in the plurality of separate measurement gaps may have different gap lengths, e.g., as discussed in reference to FIGS. 5A and 5B. The discontinuous measurement gap set may be configured with a positioning occasion periodicity, a measurement gap length for each separate measurement gap, and a gap separation between the separate measurement gaps, e.g., as discussed in reference to FIGS. 5A and 5B. Each separate measurement gap in the plurality of separate measurement gaps may be associated with the DL PRS from a different SV, e.g., as discussed in reference to FIGS. 5A and 5B. Each SV in the plurality of SVs may be in a different Earth orbit, e.g., as discussed in reference to FIGS. 5A and 5B.

FIG. 12 shows a flowchart of an example procedure 1200 for supporting positioning of a UE in a non-terrestrial network, performed by a network entity (e.g., location server, such as LMF 124 or location server 900, or a gNB, such as gNB 106, 202, 302/307, or gNB 1000).

As illustrated, at block 1202, the network entity receives a request for measurement gaps for positioning measurements in the non-terrestrial network, e.g., as discussed in in reference to FIGS. 5A and 5B. A means for receiving a request for measurement gaps for positioning measurements in the non-terrestrial network may be, e.g., the external interface 902 and one or more processors 904 with dedicated hardware or implementing executable code or software instructions in memory 916 and/or medium 918, such as the measurement gap module 922, in location server 900 in FIG. 9 or the external interface 1002 and one or more processors 1004 with dedicated hardware or implementing executable code or software instructions in memory 1016 and/or medium 1018, such as the measurement gap module 1022, in gNB 1000 in FIG. 10.

At block 1204, the network entity provides to the UE configurations for downlink (DL) positioning reference signals (PRS) associated with a plurality of SVs in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of satellite vehicles comprises a plurality of separate measurement gaps, e.g., as discussed in reference to FIGS. 5A and 5B. In some implementations, each positioning occasion may be repeated with a first periodicity and the discontinuous measurement gap set may be repeated with the first periodicity, e.g., as discussed in reference to FIGS. 5A and 5B. A means for providing to the UE configurations for downlink (DL) positioning reference signals (PRS) associated with a plurality of SVs in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of satellite vehicles comprises a plurality of separate measurement gaps may be, e.g., the external interface 902 and one or more processors 904 with dedicated hardware or implementing executable code or software instructions in memory 916 and/or medium 918, such as the assistance data module 930, in location server 900 in FIG. 9 or the external interface 1002 and one or more processors 1004 with dedicated hardware or implementing executable code or software instructions in memory 1016 and/or medium 1018, such as the assistance data module 1024, in gNB 1000 in FIG. 10.

In some implementations, for example, the at least two measurement gaps in the plurality of separate measurement gaps may have different gap lengths, e.g., as discussed in reference to FIGS. 5A and 5B. The discontinuous measurement gap set may be configured with a positioning occasion periodicity, a measurement gap length for each separate measurement gap, and a gap separation between the separate measurement gaps, e.g., as discussed in reference to FIGS. 5A and 5B. Each separate measurement gap in the plurality of separate measurement gaps may be associated with the DL PRS from a different SV, e.g., as discussed in reference to FIGS. 5A and 5B. Each SV in the plurality of SVs may be in a different Earth orbit, e.g., as discussed in reference to FIGS. 5A and 5B.

FIG. 13 shows a flowchart of an example procedure 1300 for supporting positioning of a UE in a non-terrestrial network, performed by a user equipment (e.g., a UE 105 and UE 800).

As illustrated, at block 1302, the UE receives positioning assistance data for downlink (DL) positioning resources from a plurality of SVs in the non-terrestrial network, wherein the positioning assistance data comprises at least one of expected reference signal time differences (RSTD) for the DL positioning resources from the plurality of SVs and an elevation angle of each of the plurality of SVs, e.g., as discussed in in reference to FIG. 7B. A means for receiving positioning assistance data for downlink (DL) positioning resources from a plurality of SVs in the non-terrestrial network, wherein the positioning assistance data comprises at least one of expected reference signal time differences (RSTD) for the DL positioning resources from the plurality of SVs and an elevation angle of each of the plurality of SVs may be, e.g., the wireless transceiver 802 and one or more processors 804 with dedicated hardware or implementing executable code or software instructions in memory 816 and/or medium 818, such as the assistance data module 822, in UE 800 in FIG. 8.

At block 1304, the UE determines prioritization of the DL positioning resources from the plurality of SVs based on the at least one of the expected RSTD for the DL positioning resources from the plurality of SVs and at least one of the elevation angle of each of the plurality of SVs and an Earth orbit of each of the plurality of SVs, or a combination thereof, e.g., as discussed in in reference to FIG. 7B. A means for determining prioritization of the DL positioning resources from the plurality of SVs based on the at least one of the expected RSTD for the DL positioning resources from the plurality of SVs and at least one of the elevation angle of each of the plurality of SVs and an Earth orbit of each of the plurality of SVs, or a combination thereof may be, e.g., the wireless transceiver 802 and one or more processors 804 with dedicated hardware or implementing executable code or software instructions in memory 816 and/or medium 818, such as the prioritization module 826, in UE 800 in FIG. 8.

At block 1306, the UE measures the DL positioning resources using the prioritization for the DL positioning resources, e.g., as discussed in in reference to FIG. 7B. A means for measuring the DL positioning resources using the prioritization for the DL positioning resources may be, e.g., the wireless transceiver 802 and one or more processors 804 with dedicated hardware or implementing executable code or software instructions in memory 816 and/or medium 818, such as the PRS module 828 and the positioning measurement module 830, in UE 800 in FIG. 8.

In one implementation, the UE may send a location information report to a location server based on measurements of the DL positioning resources and the prioritization of the DL positioning resources, e.g., as discussed in reference to FIG. 7B. A means for send a location information report to a location server based on measurements of the DL positioning resources and the prioritization of the DL positioning resources may be, e.g., the wireless transceiver 802 and one or more processors 804 with dedicated hardware or implementing executable code or software instructions in memory 816 and/or medium 818, such as the location information module 832, in UE 800 in FIG. 8.

FIG. 14 shows a flowchart of an example procedure 1400 for supporting positioning of a UE in a non-terrestrial network, performed by a location server, such as LMF 124 or location server 900.

As illustrated, at block 1402, the location server generates a prioritization for downlink (DL) positioning resources from a plurality of SVs in the non-terrestrial network based on at least one of expected reference signal time differences (RSTD) for a plurality of DL positioning resources at least one of an elevation angle of each of the plurality of SVs and an Earth orbit of each of the plurality of SVs, or a combination thereof, as discussed in reference to FIG. 7B. A means for generating a prioritization for downlink (DL) positioning resources from a plurality of SVs in the non-terrestrial network based on at least one of expected reference signal time differences (RSTD) for a plurality of DL positioning resources at least one of an elevation angle of each of the plurality of SVs and an Earth orbit of each of the plurality of SVs, or a combination thereof may be, e.g., the one or more processors 904 with dedicated hardware or implementing executable code or software instructions in memory 916 and/or medium 918, such as the prioritization module 924, in location server 900 in FIG. 9.

At block 1404, the location server sends positioning assistance data for the DL positioning resources to the UE including the prioritization of the DL positioning resources, e.g., as discussed in reference to FIG. 7B. A means for sending positioning assistance data for the DL positioning resources to the UE including the prioritization of the DL positioning resources may be, e.g., the external interface 902 and one or more processors 904 with dedicated hardware or implementing executable code or software instructions in memory 916 and/or medium 918, such as the assistance data module 930, in location server 900 in FIG. 9.

In one implementation, the location server receives a location information report from the UE based on UE measurements of the DL positioning resources and the prioritization of the DL positioning resources, e.g., as discussed in reference to FIG. 7B. A means for receiving a location information report from the UE based on UE measurements of the DL positioning resources and the prioritization of the DL positioning resources may be, e.g., the external interface 902 and one or more processors 904 with dedicated hardware or implementing executable code or software instructions in memory 916 and/or medium 918, such as the location information module 932, in location server 900 in FIG. 9.

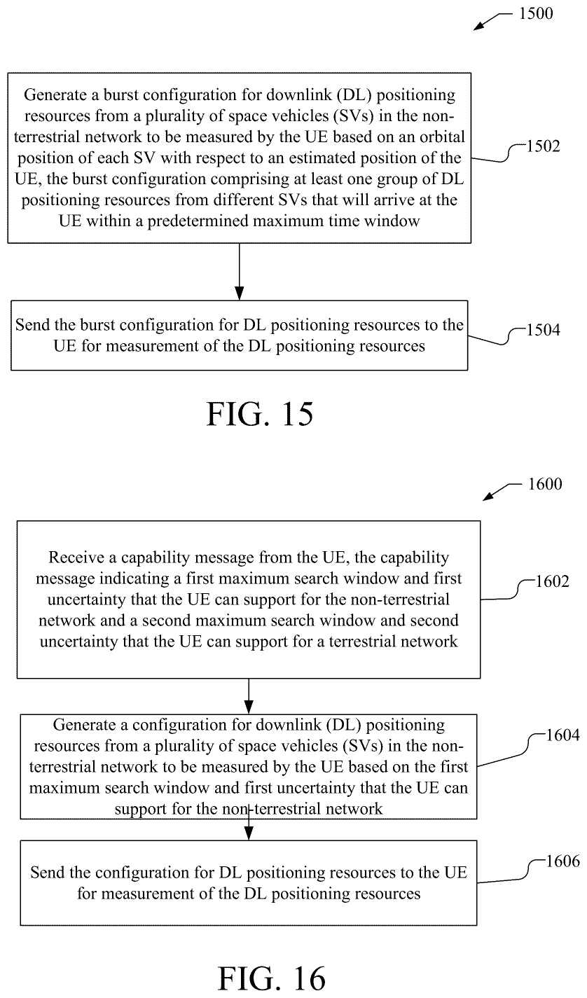

FIG. 15 shows a flowchart of an example procedure 1500 for supporting positioning of a UE in a non-terrestrial network, performed by a location server, such as LMF 124 or location server 900.

As illustrated, at block 1502, the location server generates a burst configuration for downlink (DL) positioning resources from a plurality of SVs in the non-terrestrial network to be measured by the UE based on an orbital position of each SV with respect to an estimated position of the UE, the burst configuration comprising at least one group of DL positioning resources from different SVs that will arrive at the UE within a predetermined maximum time window, e.g., as discussed in reference to FIG. 6. The different SVs, for example, may be in different Earth orbits, e.g., as discussed in reference to FIG. 6. In some implementations, the burst configuration for the DL positioning resources may include a plurality of groups of DL positioning resources, each group of DL positioning resources associated with a different set of SVs and each group of DL positioning resources configured to arrive at the UE at a different time, e.g., as discussed in reference to FIG. 6. A means for generating a burst configuration for downlink (DL) positioning resources from a plurality of SVs in the non-terrestrial network to be measured by the UE based on an orbital position of each SV with respect to an estimated position of the UE, the burst configuration comprising at least one group of DL positioning resources from different SVs that will arrive at the UE within a predetermined maximum time may be, e.g., the one or more processors 904 with dedicated hardware or implementing executable code or software instructions in memory 916 and/or medium 918, such as the burst module 926, in location server 900 in FIG. 9.

At block 1504, the location server sends the burst configuration for DL positioning resources to the UE for measurement of the DL positioning resources, e.g., as discussed in reference to FIG. 6. A means for sending the burst configuration for DL positioning resources to the UE for measurement of the DL positioning resources may be, e.g., the external interface 902 and one or more processors 904 with dedicated hardware or implementing executable code or software instructions in memory 916 and/or medium 918, such as the assistance data module 930, in location server 900 in FIG. 9.

FIG. 16 shows a flowchart of an example procedure 1600 for supporting positioning of a UE in a non-terrestrial network, performed by a location server, such as LMF 124 or location server 900.

As illustrated, at block 1602, the location server receives a capability message from the UE, the capability message indicating a first maximum search window and first uncertainty that the UE can support for the non-terrestrial network and a second maximum search window and second uncertainty that the UE can support for a terrestrial network. The first maximum search window, for example, may be greater than the second maximum search window. The first maximum search window may be a number of symbols that the UE can search for a DL positioning resource. A means for receiving a capability message from the UE, the capability message indicating a first maximum search window and first uncertainty that the UE can support for the non-terrestrial network and a second maximum search window and second uncertainty that the UE can support for a terrestrial network may be, e.g., the one or more processors 904 with dedicated hardware or implementing executable code or software instructions in memory 916 and/or medium 918, such as the capabilities module 928, in location server 900 in FIG. 9.

At block 1604, the location server generates a configuration for downlink (DL) positioning resources from a plurality of SVs in the non-terrestrial network to be measured by the UE based on the first maximum search window and first uncertainty that the UE can support for the non-terrestrial network. A means for generating a configuration for downlink (DL) positioning resources from a plurality of SVs in the non-terrestrial network to be measured by the UE based on the first maximum search window and first uncertainty that the UE can support for the non-terrestrial network may be, e.g., the one or more processors 904 with dedicated hardware or implementing executable code or software instructions in memory 916 and/or medium 918, such as the assistance data module 930, in location server 900 in FIG. 9.

At block 1606, the location server sends the configuration for DL positioning resources to the UE for measurement of the DL positioning resource. A means for sending the configuration for DL positioning resources to the UE for measurement of the DL positioning resources may be, e.g., the external interface 902 and one or more processors 904 with dedicated hardware or implementing executable code or software instructions in memory 916 and/or medium 918, such as the assistance data module 928, in location server 900 in FIG. 9.

Substantial variations may be made in accordance with specific desires. For example, customized hardware might also be used, and/or particular elements might be implemented in hardware, software (including portable software, such as applets, etc.), or both. Further, connection to other computing devices such as network input/output devices may be employed.

Configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device, user equipment (UE), or mobile station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device”. “wireless device” or “user equipment”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, a “mobile station” or “user equipment” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above is also considered a “mobile station” or “user equipment.” A mobile device or user equipment (UE) may also be referred to as a mobile terminal, a terminal, a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

In view of this description embodiments may include different combinations of features. Implementation examples are described in the following numbered clauses:

Clause 1. A method performed by a user equipment (UE) for supporting positioning of the UE in a non-terrestrial network, the method comprising: receiving configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SV, wherein the discontinuous measurement gap set for each positioning occasion for processing the DL PRS from the plurality of SV comprises a plurality of separate measurement gaps; receiving the DL PRS from the plurality of SV using the discontinuous measurement gap set; performing positioning measurements using the DL PRS from the plurality of SV; and transmitting location information based on the positioning measurements to a location server.

Clause 2. The method of clause 1, wherein each positioning occasion is repeated with a first periodicity and wherein the discontinuous measurement gap set is repeated with the first periodicity.

Clause 3. The method of any of clauses 1-2, wherein at least two measurement gaps in the plurality of separate measurement gaps have different gap lengths.

Clause 4. The method of any of clauses 1-3, wherein the discontinuous measurement gap set is configured with a positioning occasion periodicity, a measurement gap length for each separate measurement gap, and a gap separation between the separate measurement gaps.

Clause 5. The method of any of clauses 1-4, wherein each separate measurement gap in the plurality of separate measurement gaps is associated with the DL PRS from a different satellite vehicle.

Clause 6. The method of any of clauses 1-5, wherein each satellite vehicle in the plurality of SV is in a different Earth orbit.

Clause 7. A user equipment (UE) configured for supporting positioning of the UE in a non-terrestrial network, comprising: at least one wireless transceiver configured to wirelessly communicate with entities in the non-terrestrial network; at least one memory; and at least one processor coupled to the at least one wireless transceiver and the at least one memory and configured to: receive, via the at least one wireless transceiver, configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SV, wherein the discontinuous measurement gap set for each positioning occasion for processing the DL PRS from the plurality of SV comprises a plurality of separate measurement gaps; receive, via the at least one wireless transceiver, the DL PRS from the plurality of SV using the discontinuous measurement gap set; perform positioning measurements using the DL PRS from the plurality of SV; and transmit, via the at least one wireless transceiver, location information based on the positioning measurements to a location server.

Clause 8. The UE of clause 7, wherein each positioning occasion is repeated with a first periodicity and wherein the discontinuous measurement gap set is repeated with the first periodicity.

Clause 9. The UE of any of clauses 7-8, wherein at least two measurement gaps in the plurality of separate measurement gaps have different gap lengths.

Clause 10. The UE of any of clauses 7-9, wherein the discontinuous measurement gap set is configured with a positioning occasion periodicity, a measurement gap length for each separate measurement gap, and a gap separation between the separate measurement gaps.

Clause 11. The UE of any of clauses 7-10, wherein each separate measurement gap in the plurality of separate measurement gaps is associated with the DL PRS from a different satellite vehicle.

Clause 12. The UE of any of clauses 7-11, wherein each satellite vehicle in the plurality of SV is in a different Earth orbit.

Clause 13. A user equipment (UE) configured for supporting positioning of the UE in a non-terrestrial network, comprising: means for receiving configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SV, wherein the discontinuous measurement gap set for each positioning occasion for processing the DL PRS from the plurality of SV comprises a plurality of separate measurement gaps; means for receiving the DL PRS from the plurality of SV using the discontinuous measurement gap set; means for performing positioning measurements using the DL PRS from the plurality of SV; and means for transmitting location information based on the positioning measurements to a location server.

Clause 14. The UE of clause 13, wherein each positioning occasion is repeated with a first periodicity and wherein the discontinuous measurement gap set is repeated with the first periodicity.

Clause 15. The UE of any of clauses 13-14, wherein at least two measurement gaps in the plurality of separate measurement gaps have different gap lengths.

Clause 16. The UE of any of clauses 13-15, wherein the discontinuous measurement gap set is configured with a positioning occasion periodicity, a measurement gap length for each separate measurement gap, and a gap separation between the separate measurement gaps.

Clause 17. The UE of any of clauses 13-16, wherein each separate measurement gap in the plurality of separate measurement gaps is associated with the DL PRS from a different satellite vehicle.

Clause 18. The UE of any of clauses 13-17, wherein each satellite vehicle in the plurality of SV is in a different Earth orbit.

Clause 19. A non-transitory computer-readable storage medium including program code stored thereon, the program code is operable to configure at least one processor in a user equipment (UE) configured for supporting positioning of the UE in a non-terrestrial network, the program code comprising instructions to: receive configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SV, wherein the discontinuous measurement gap set for each positioning occasion for processing the DL PRS from the plurality of SV comprises a plurality of separate measurement gaps; receive the DL PRS from the plurality of SV using the discontinuous measurement gap set; perform positioning measurements using the DL PRS from the plurality of SV; and transmit location information based on the positioning measurements to a location server.

Clause 20. The non-transitory computer-readable storage medium of clause 19, wherein each positioning occasion is repeated with a first periodicity and wherein the discontinuous measurement gap set is repeated with the first periodicity.

Clause 21. The non-transitory computer-readable storage medium of any of clauses 19-20, wherein at least two measurement gaps in the plurality of separate measurement gaps have different gap lengths.

Clause 22. The non-transitory computer-readable storage medium of any of clauses 19-21, wherein the discontinuous measurement gap set is configured with a positioning occasion periodicity, a measurement gap length for each separate measurement gap, and a gap separation between the separate measurement gaps.

Clause 23. The non-transitory computer-readable storage medium of any of clauses 19-22, wherein each separate measurement gap in the plurality of separate measurement gaps is associated with the DL PRS from a different satellite vehicle.

Clause 24. The non-transitory computer-readable storage medium of any of clauses 19-23, wherein each satellite vehicle in the plurality of SV is in a different Earth orbit.

Clause 25. A method performed by a network entity for supporting positioning of a user equipment (UE) in a non-terrestrial network, the method comprising: receiving a request for measurement gaps for positioning measurements in the non-terrestrial network; and providing to the UE configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SV, wherein the discontinuous measurement gap set for each positioning occasion for processing the DL PRS from the plurality of SV comprises a plurality of separate measurement gaps for each positioning occasion.

Clause 26. The method of clause 25, wherein each positioning occasion is repeated with a first periodicity and wherein the discontinuous measurement gap set is repeated with the first periodicity.

Clause 27. The method of any of clauses 25-26, wherein at least two measurement gaps in the plurality of separate measurement gaps have different gap lengths.

Clause 28. The method of any of clauses 25-27, wherein the discontinuous measurement gap set is configured with a positioning occasion periodicity, a measurement gap length for each separate measurement gap, and a gap separation between the separate measurement gaps.

Clause 29. The method of any of clauses 25-28, wherein each separate measurement gap in the plurality of separate measurement gaps is associated with the DL PRS from a different satellite vehicle.

Clause 30. The method of any of clauses 25-29, wherein each satellite vehicle in the plurality of SV is in a different Earth orbit.

Clause 31. The method of any of clauses 25-30, wherein the network entity is one of a location server or a gNB.

Clause 32. A network entity configured for supporting positioning of a user equipment (UE) in a non-terrestrial network, comprising: an external interface configured to wirelessly communicate with entities in the non-terrestrial network; at least one memory; and at least one processor coupled to the external interface and the at least one memory and configured to: receive, via the external interface, a request for measurement gaps for positioning measurements in the non-terrestrial network; and provide, via the external interface, to the UE configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SV, wherein the discontinuous measurement gap set for each positioning occasion for processing the DL PRS from the plurality of SV comprises a plurality of separate measurement gaps for each positioning occasion.

Clause 33. The network entity of clause 32, wherein each positioning occasion is repeated with a first periodicity and wherein the discontinuous measurement gap set is repeated with the first periodicity.

Clause 34. The network entity of any of clauses 32-33, wherein at least two measurement gaps in the plurality of separate measurement gaps have different gap lengths.

Clause 35. The network entity of any of clauses 32-34, wherein the discontinuous measurement gap set is configured with a positioning occasion periodicity, a measurement gap length for each separate measurement gap, and a gap separation between the separate measurement gaps.

Clause 36. The network entity of any of clauses 32-35, wherein each separate measurement gap in the plurality of separate measurement gaps is associated with the DL PRS from a different satellite vehicle.

Clause 37. The network entity of any of clauses 32-36, wherein each satellite vehicle in the plurality of SV is in a different Earth orbit.

Clause 38. The network entity of any of clauses 32-37, wherein the network entity is one of a location server or a gNB.

Clause 39. A network entity configured for supporting positioning of a user equipment (UE) in a non-terrestrial network, comprising: means for receiving a request for measurement gaps for positioning measurements in the non-terrestrial network; and means for providing to the UE configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SV, wherein the discontinuous measurement gap set for each positioning occasion for processing the DL PRS from the plurality of SV comprises a plurality of separate measurement gaps for each positioning occasion.

Clause 40. The network entity of clause 39, wherein each positioning occasion is repeated with a first periodicity and wherein the discontinuous measurement gap set is repeated with the first periodicity.

Clause 41. The network entity of any of clauses 39-40, wherein at least two measurement gaps in the plurality of separate measurement gaps have different gap lengths.

Clause 42. The network entity of any of clauses 39-41, wherein the discontinuous measurement gap set is configured with a positioning occasion periodicity, a measurement gap length for each separate measurement gap, and a gap separation between the separate measurement gaps.

Clause 43. The network entity of any of clauses 39-42, wherein each separate measurement gap in the plurality of separate measurement gaps is associated with the DL PRS from a different satellite vehicle.

Clause 44. The network entity of any of clauses 39-43, wherein each satellite vehicle in the plurality of SV is in a different Earth orbit.

Clause 45. The network entity of any of clauses 39-44, wherein the network entity is one of a location server or a gNB.

Clause 46. A non-transitory computer-readable storage medium including program code stored thereon, the program code is operable to configure at least one processor in a network entity for supporting positioning of a user equipment (UE) in a non-terrestrial network, the program code comprising instructions to: receive a request for measurement gaps for positioning measurements in the non-terrestrial network; and provide to the UE configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SV, wherein the discontinuous measurement gap set for each positioning occasion for processing the DL PRS from the plurality of SV comprises a plurality of separate measurement gaps for each positioning occasion.

Clause 47. The non-transitory computer-readable storage medium of clause 46, wherein each positioning occasion is repeated with a first periodicity and wherein the discontinuous measurement gap set is repeated with the first periodicity.

Clause 48. The non-transitory computer-readable storage medium of any of clauses 46-47, wherein at least two measurement gaps in the plurality of separate measurement gaps have different gap lengths.

Clause 49. The non-transitory computer-readable storage medium of any of clauses 46-48, wherein the discontinuous measurement gap set is configured with a positioning occasion periodicity, a measurement gap length for each separate measurement gap, and a gap separation between the separate measurement gaps.

Clause 50. The non-transitory computer-readable storage medium of any of clauses 46-49, wherein each separate measurement gap in the plurality of separate measurement gaps is associated with the DL PRS from a different satellite vehicle.

Clause 51. The non-transitory computer-readable storage medium of any of clauses 46-50, wherein each satellite vehicle in the plurality of SV is in a different Earth orbit.

Clause 52. The non-transitory computer-readable storage medium of any of clauses 46-51, wherein the network entity is one of a location server or a gNB.

Clause 53. A method performed by a user equipment (UE) for supporting positioning of the UE in a non-terrestrial network, the method comprising: receiving positioning assistance data for downlink (DL) positioning resources from a plurality of space vehicles (SVs) in the non-terrestrial network, wherein the positioning assistance data comprises at least one of expected reference signal time differences (RSTD) for the DL positioning resources from the plurality of SV and an elevation angle of each of the plurality of SV; determining prioritization of the DL positioning resources from the plurality of SV based on the at least one of the expected RSTD for the DL positioning resources from the plurality of SV and at least one of the elevation angle of each of the plurality of SV and an Earth orbit of each of the plurality of SV, or a combination thereof; and measuring the DL positioning resources using the prioritization for the DL positioning resources.

Clause 54. The method of clause 53, further comprising sending a location information report to a location server based on measurements of the DL positioning resources and the prioritization of the DL positioning resources.

Clause 55. A user equipment (UE) configured for supporting positioning of the UE in a non-terrestrial network, comprising: at least one wireless transceiver configured to wirelessly communicate with entities in the non-terrestrial network; at least one memory; and at least one processor coupled to the at least one wireless transceiver and the at least one memory and configured to: receive, via the at least one wireless transceiver, positioning assistance data for downlink (DL) positioning resources from a plurality of space vehicles (SVs) in the non-terrestrial network, wherein the positioning assistance data comprises at least one of expected reference signal time differences (RSTD) for the DL positioning resources from the plurality of SV and an elevation angle of each of the plurality of SV; determine prioritization of the DL positioning resources from the plurality of SV based on the at least one of the expected RSTD for the DL positioning resources from the plurality of SV and at least one of the elevation angle of each of the plurality of SV and an Earth orbit of each of the plurality of SV, or a combination thereof; and measure the DL positioning resources using the prioritization for the DL positioning resources.

Clause 56. The UE of clause 55, wherein the at least one processor is further configured to send, via the at least one wireless transceiver, a location information report to a location server based on measurements of the DL positioning resources and the prioritization of the DL positioning resources.

Clause 57. A user equipment (UE) configured for supporting positioning of the UE in a non-terrestrial network, comprising: means for receiving positioning assistance data for downlink (DL) positioning resources from a plurality of space vehicles (SVs) in the non-terrestrial network, wherein the positioning assistance data comprises at least one of expected reference signal time differences (RSTD) for the DL positioning resources from the plurality of SV and an elevation angle of each of the plurality of SV; means for determining prioritization of the DL positioning resources from the plurality of SV based on the at least one of the expected RSTD for the DL positioning resources from the plurality of SV and at least one of the elevation angle of each of the plurality of SV and an Earth orbit of each of the plurality of SV, or a combination thereof; and means for measuring the DL positioning resources using the prioritization for the DL positioning resources.

Clause 58. The UE of clause 57, further comprising means for sending a location information report to a location server based on measurements of the DL positioning resources and the prioritization of the DL positioning resources.

Clause 59. A non-transitory computer-readable storage medium including program code stored thereon, the program code is operable to configure at least one processor in a user equipment (UE) for supporting positioning of the UE in a non-terrestrial network, the program code comprising instructions to: receive positioning assistance data for downlink (DL) positioning resources from a plurality of space vehicles (SVs) in the non-terrestrial network, wherein the positioning assistance data comprises at least one of expected reference signal time differences (RSTD) for the DL positioning resources from the plurality of SV and an elevation angle of each of the plurality of SV; determine prioritization of the DL positioning resources from the plurality of SV based on the at least one of the expected RSTD for the DL positioning resources from the plurality of SV and at least one of the elevation angle of each of the plurality of SV and an Earth orbit of each of the plurality of SV, or a combination thereof; and measure the DL positioning resources using the prioritization for the DL positioning resources.

Clause 60. The non-transitory computer-readable storage medium of clause 59, wherein the program code further comprises instructions to send a location information report to a location server based on measurements of the DL positioning resources and the prioritization of the DL positioning resources.

Clause 61. A method performed by a location server for supporting positioning of a user equipment (UE) in a non-terrestrial network, the method comprising: generating a prioritization for downlink (DL) positioning resources from a plurality of space vehicles (SVs) in the non-terrestrial network based on at least one of expected reference signal time differences (RSTD) for a plurality of DL positioning resources at least one of an elevation angle of each of the plurality of SV and an Earth orbit of each of the plurality of SV, or a combination thereof; sending positioning assistance data for the DL positioning resources to the UE including the prioritization of the DL positioning resources.

Clause 62. The method of clause 61, further comprising receiving a location information report from the UE based on UE measurements of the DL positioning resources and the prioritization of the DL positioning resources.

Clause 63. A location server configured for supporting positioning of a user equipment (UE) in a non-terrestrial network, comprising: an external interface configured to wirelessly communicate with entities in the non-terrestrial network; at least one memory; and at least one processor coupled to the external interface and the at least one memory and configured to: generate a prioritization for downlink (DL) positioning resources from a plurality of space vehicles (SVs) in the non-terrestrial network based on at least one of expected reference signal time differences (RSTD) for a plurality of DL positioning resources at least one of an elevation angle of each of the plurality of SV and an Earth orbit of each of the plurality of SV, or a combination thereof; send, via the external interface, positioning assistance data for the DL positioning resources to the UE including the prioritization of the DL positioning resources.

Clause 64. The location server of clause 63, wherein the at least one processor is further configured to receive, via the external interface, a location information report from the UE based on UE measurements of the DL positioning resources and the prioritization of the DL positioning resources.

Clause 65. A location server configured for supporting positioning of a user equipment (UE) in a non-terrestrial network, comprising: means for generating a prioritization for downlink (DL) positioning resources from a plurality of space vehicles (SVs) in the non-terrestrial network based on at least one of expected reference signal time differences (RSTD) for a plurality of DL positioning resources at least one of an elevation angle of each of the plurality of SV and an Earth orbit of each of the plurality of SV, or a combination thereof; means for sending positioning assistance data for the DL positioning resources to the UE including the prioritization of the DL positioning resources.

Clause 66. The location server of clause 65, further comprising means for receiving a location information report from the UE based on UE measurements of the DL positioning resources and the prioritization of the DL positioning resources.

Clause 67. A non-transitory computer-readable storage medium including program code stored thereon, the program code is operable to configure at least one processor in a location server for supporting positioning of a user equipment (UE) in a non-terrestrial network, the program code comprising instructions to: generate a prioritization for downlink (DL) positioning resources from a plurality of space vehicles (SVs) in the non-terrestrial network based on at least one of expected reference signal time differences (RSTD) for a plurality of DL positioning resources at least one of an elevation angle of each of the plurality of SV and an Earth orbit of each of the plurality of SV, or a combination thereof; send positioning assistance data for the DL positioning resources to the UE including the prioritization of the DL positioning resources.

Clause 68. The non-transitory computer-readable storage medium of clause 67, wherein the program code further comprises instructions to receive a location information report from the UE based on UE measurements of the DL positioning resources and the prioritization of the DL positioning resources.

Clause 69. A method performed by a location server for supporting positioning of a user equipment (UE) in a non-terrestrial network, the method comprising: generating a burst configuration for downlink (DL) positioning resources from a plurality of space vehicles (SVs) in the non-terrestrial network to be measured by the UE based on an orbital position of each satellite vehicle with respect to an estimated position of the UE, the burst configuration comprising at least one group of DL positioning resources from different SV that will arrive at the UE within a predetermined maximum time window; and sending the burst configuration for DL positioning resources to the UE for measurement of the DL positioning resources.

Clause 70. The method of clause 69, wherein the different SV are in different Earth orbits.

Clause 71. The method of any of clauses 69-70, wherein the burst configuration for the DL positioning resources comprises a plurality of groups of DL positioning resources, each group of DL positioning resources associated with a different set of SV and each group of DL positioning resources configured to arrive at the UE at a different time.

Clause 72. A location server configured for supporting positioning of a user equipment (UE) in a non-terrestrial network, comprising: an external interface configured to wirelessly communicate with entities in the non-terrestrial network; at least one memory; and at least one processor coupled to the external interface and the at least one memory and configured to: generate a burst configuration for downlink (DL) positioning resources from a plurality of space vehicles (SVs) in the non-terrestrial network to be measured by the UE based on an orbital position of each satellite vehicle with respect to an estimated position of the UE, the burst configuration comprising at least one group of DL positioning resources from different SV that will arrive at the UE within a predetermined maximum time window; and send, via the external interface, the burst configuration for DL positioning resources to the UE for measurement of the DL positioning resources.

Clause 73. The location server of clause 72, wherein the different SV are in different Earth orbits.

Clause 74. The location server of any of clauses 72-73, wherein the burst configuration for the DL positioning resources comprises a plurality of groups of DL positioning resources, each group of DL positioning resources associated with a different set of SV and each group of DL positioning resources configured to arrive at the UE at a different time.

Clause 75. A location server configured for supporting positioning of a user equipment (UE) in a non-terrestrial network, comprising: means for generating a burst configuration for downlink (DL) positioning resources from a plurality of space vehicles (SVs) in the non-terrestrial network to be measured by the UE based on an orbital position of each satellite vehicle with respect to an estimated position of the UE, the burst configuration comprising at least one group of DL positioning resources from different SV that will arrive at the UE within a predetermined maximum time window; and means for sending the burst configuration for DL positioning resources to the UE for measurement of the DL positioning resources.

Clause 76. The location server of clause 75, wherein the different SV are in different Earth orbits.

Clause 77. The location server of any of clauses 75-76, wherein the burst configuration for the DL positioning resources comprises a plurality of groups of DL positioning resources, each group of DL positioning resources associated with a different set of SV and each group of DL positioning resources configured to arrive at the UE at a different time.

Clause 78. A non-transitory computer-readable storage medium including program code stored thereon, the program code is operable to configure at least one processor in a location server for supporting positioning of a user equipment (UE) in a non-terrestrial network, the program code comprising instructions to: generate a burst configuration for downlink (DL) positioning resources from a plurality of space vehicles (SVs) in the non-terrestrial network to be measured by the UE based on an orbital position of each satellite vehicle with respect to an estimated position of the UE, the burst configuration comprising at least one group of DL positioning resources from different SV that will arrive at the UE within a predetermined maximum time window; and send the burst configuration for DL positioning resources to the UE for measurement of the DL positioning resources.

Clause 79. The non-transitory computer-readable storage medium of clause 78, wherein the different SV are in different Earth orbits.

Clause 80. The non-transitory computer-readable storage medium of any of clauses 78-79, wherein the burst configuration for the DL positioning resources comprises a plurality of groups of DL positioning resources, each group of DL positioning resources associated with a different set of SV and each group of DL positioning resources configured to arrive at the UE at a different time.

Clause 81. A method performed by a location server for supporting positioning of a user equipment (UE) in a non-terrestrial network, the method comprising: receiving a capability message from the UE, the capability message indicating a first maximum search window and first uncertainty that the UE can support for the non-terrestrial network and a second maximum search window and second uncertainty that the UE can support for a terrestrial network; generating a configuration for downlink (DL) positioning resources from a plurality of space vehicles (SVs) in the non-terrestrial network to be measured by the UE based on the first maximum search window and first uncertainty that the UE can support for the non-terrestrial network; and sending the configuration for DL positioning resources to the UE for measurement of the DL positioning resources.

Clause 82. The method of clause 81, wherein the first maximum search window is greater than the second maximum search window.

Clause 83. The method of any of clauses 81-82, wherein the first maximum search window is a number of symbols that the UE can search for a DL positioning resource.

Clause 84. A location server configured for supporting positioning of a user equipment (UE) in a non-terrestrial network, comprising: an external interface configured to wirelessly communicate with entities in the non-terrestrial network; at least one memory; and at least one processor coupled to the external interface and the at least one memory and configured to: receive, via the external interface, a capability message from the UE, the capability message indicating a first maximum search window and first uncertainty that the UE can support for the non-terrestrial network and a second maximum search window and second uncertainty that the UE can support for a terrestrial network; generate a configuration for downlink (DL) positioning resources from a plurality of space vehicles (SVs) in the non-terrestrial network to be measured by the UE based on the first maximum search window and first uncertainty that the UE can support for the non-terrestrial network; and send, via the external interface, the configuration for DL positioning resources to the UE for measurement of the DL positioning resources.

Clause 85. The location server of clause 84, wherein the first maximum search window is greater than the second maximum search window.

Clause 86. The location server of any of clauses 84-85, wherein the first maximum search window is a number of symbols that the UE can search for a DL positioning resource.

Clause 87. A location server configured for supporting positioning of a user equipment (UE) in a non-terrestrial network, comprising: means for receiving a capability message from the UE, the capability message indicating a first maximum search window and first uncertainty that the UE can support for the non-terrestrial network and a second maximum search window and second uncertainty that the UE can support for a terrestrial network; means for generating a configuration for downlink (DL) positioning resources from a plurality of space vehicles (SVs) in the non-terrestrial network to be measured by the UE based on the first maximum search window and first uncertainty that the UE can support for the non-terrestrial network; and means for sending the configuration for DL positioning resources to the UE for measurement of the DL positioning resources.

Clause 88. The location server of clause 87, wherein the first maximum search window is greater than the second maximum search window.

Clause 89. The location server of any of clauses 87-88, wherein the first maximum search window is a number of symbols that the UE can search for a DL positioning resource.

Clause 90. A non-transitory computer-readable storage medium including program code stored thereon, the program code is operable to configure at least one processor in a location server for supporting positioning of a user equipment (UE) in a non-terrestrial network, the program code comprising instructions to: receive a capability message from the UE, the capability message indicating a first maximum search window and first uncertainty that the UE can support for the non-terrestrial network and a second maximum search window and second uncertainty that the UE can support for a terrestrial network; generate a configuration for downlink (DL) positioning resources from a plurality of space vehicles (SVs) in the non-terrestrial network to be measured by the UE based on the first maximum search window and first uncertainty that the UE can support for the non-terrestrial network; and send the configuration for DL positioning resources to the UE for measurement of the DL positioning resources.

Clause 91. The non-transitory computer-readable storage medium of clause 90, wherein the first maximum search window is greater than the second maximum search window.

Clause 92. The non-transitory computer-readable storage medium of any of clauses 90-91, wherein the first maximum search window is a number of symbols that the UE can search for a DL positioning resource.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method performed by a user equipment (UE) for supporting positioning of the UE in a non-terrestrial network, the method comprising:
receiving configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SV comprises a plurality of separate measurement gaps;
receiving the DL PRS from the plurality of SVs using the discontinuous measurement gap set;
performing positioning measurements using the DL PRS from the plurality of SVs; and
transmitting location information based on the positioning measurements to a location server.

2. The method of claim 1, wherein each positioning occasion is repeated with a first periodicity and wherein the discontinuous measurement gap set is repeated with the first periodicity.

3. The method of claim 1, wherein at least two measurement gaps in the plurality of separate measurement gaps have different gap lengths.

4. The method of claim 1, wherein the discontinuous measurement gap set is configured with a positioning occasion periodicity, a measurement gap length for each separate measurement gap, and a gap separation between the separate measurement gaps.

5. The method of claim 1, wherein each separate measurement gap in the plurality of separate measurement gaps is associated with the DL PRS from a different SV.

6. The method of claim 1, wherein each SV in the plurality of SVs is in a different Earth orbit.

7. A user equipment (UE) configured for supporting positioning of the UE in a non-terrestrial network, comprising:
at least one wireless transceiver configured to wirelessly communicate with entities in the non-terrestrial network;
at least one memory; and
at least one processor coupled to the at least one wireless transceiver and the at least one memory and configured to:
receive, via the at least one wireless transceiver, configurations for downlink (DL) positioning reference signals (PRS) associated with a plurality of space vehicles SVs in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SV comprises a plurality of separate measurement gaps;
receive, via the at least one wireless transceiver, the DL PRS from the plurality of SVs using the discontinuous measurement gap set;
perform positioning measurements using the DL PRS from the plurality of SVs; and
transmit, via the at least one wireless transceiver, location information based on the positioning measurements to a location server.

8. The UE of claim 7, wherein each positioning occasion is repeated with a first periodicity and wherein the discontinuous measurement gap set is repeated with the first periodicity.

9. The UE of claim 7, wherein at least two measurement gaps in the plurality of separate measurement gaps have different gap lengths.

10. The UE of claim 7, wherein the discontinuous measurement gap set is configured with a positioning occasion periodicity, a measurement gap length for each separate measurement gap, and a gap separation between the separate measurement gaps.

11. The UE of claim 7, wherein each separate measurement gap in the plurality of separate measurement gaps is associated with the DL PRS from a different SV.

12. The UE of claim 7, wherein each SV in the plurality of SVs is in a different Earth orbit.

13. A method performed by a network entity for supporting positioning of a user equipment (UE) in a non-terrestrial network, the method comprising:
receiving a request for measurement gaps for positioning measurements in the non-terrestrial network; and
providing to the UE configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SVs comprises a plurality of separate measurement gaps for each positioning occasion.

14. The method of claim 13, wherein each positioning occasion is repeated with a first periodicity and wherein the discontinuous measurement gap set is repeated with the first periodicity.

15. The method of claim 13, wherein at least two measurement gaps in the plurality of separate measurement gaps have different gap lengths.

16. The method of claim 13, wherein the discontinuous measurement gap set is configured with a positioning occasion periodicity, a measurement gap length for each separate measurement gap, and a gap separation between the separate measurement gaps.

17. The method of claim 13, wherein each separate measurement gap in the plurality of separate measurement gaps is associated with the DL PRS from a different SV.

18. The method of claim 13, wherein each SV in the plurality of SVs is in a different Earth orbit.

19. The method of claim 13, wherein the network entity is one of a location server or a gNB.

20. A network entity configured for supporting positioning of a user equipment (UE) in a non-terrestrial network, comprising:
an external interface configured to wirelessly communicate with entities in the non-terrestrial network;
at least one memory; and
at least one processor coupled to the external interface and the at least one memory and configured to:
receive, via the external interface, a request for measurement gaps for positioning measurements in the non-terrestrial network; and
provide, via the external interface, to the UE configurations for downlink (DL) positioning reference signals (PRS) associated with a plurality of space vehicles (SVs) in the non-terrestrial network, wherein the configurations comprise a discontinuous measurement gap set for each positioning occasion for processing the DL PRS from the plurality of SVs, wherein the discontinuous measurement gap set for each positioning occasion for processing the DL PRS from the plurality of SVs comprises a plurality of separate measurement gaps for each positioning occasion.

21. The network entity of claim 20, wherein each positioning occasion is repeated with a first periodicity and wherein the discontinuous measurement gap set is repeated with the first periodicity.

22. The network entity of claim 20, wherein at least two measurement gaps in the plurality of separate measurement gaps have different gap lengths.

23. The network entity of claim 20, wherein the discontinuous measurement gap set is configured with a positioning occasion periodicity, a measurement gap length for each separate measurement gap, and a gap separation between the separate measurement gaps.

24. The network entity of claim 20, wherein each separate measurement gap in the plurality of separate measurement gaps is associated with the DL PRS from a different SV.

25. The network entity of claim 20, wherein each SV in the plurality of SVs is in a different Earth orbit.

26. The network entity of claim 20, wherein the network entity is one of a location server or a gNB.
